(19) United States
(12) Patent Application Publication
(10) Pub. No.: US 2008/0033750 A1
(43) Pub. Date: Feb. 7, 2008

(54) ENHANCED SYSTEMS AND METHODS FOR PROCESSING OF HEALTHCARE INFORMATION

(75) Inventors: Melony D. Burriss, Westminster, SC (US); Dale E. Hoerle, Naperville, IL (US); Dan Spirek, Parker, CO (US)

Correspondence Address: FULBRIGHT & JAWORSKI L.L.P, 2200 ROSS AVENUE, SUITE 2800, DALLAS, TX, 75201-2784, US

(73) Assignee: The TriZetto Group, Inc., Greenwood Village, CO (US)

(21) Appl. No.: 11/757,154

(22) Filed: Jun. 1, 2007

Related U.S. Application Data
(60) Provisional application No. 60/811,192, filed on Jun. 2, 2006.

(51) Int. Cl. G06Q 50/00

(52) U.S. Cl. 705/2

(57) ABSTRACT

Enhanced systems and methods for processing of healthcare information are provided. According to one embodiment, a method comprises receiving, at a claim processing system that is operable to adjudicate a claim for payment from an insurer for services rendered to a healthcare consumer, a request for estimated healthcare payment information. The request may pertain to a service that has not been rendered to the healthcare consumer. The request for the estimated healthcare information may be received (e.g., electronically, such as via a web interface, and/or otherwise via a communication network, such as the Internet) from the healthcare consumer or from a healthcare service provider. The method further comprises processing the request by the claim processing system for determining the requested estimated healthcare payment information. The method further comprises communicating, from the claim processing system, a response to the request that includes the estimated healthcare payment information.

### CROSS-REFERENCE TO RELATED APPLICATIONS

This application claims priority to U.S. Provisional Patent Application Ser. No. 60/811,192 entitled “Enhanced Systems and Methods for Processing of I-Healthcare Information”, filed Jun. 2, 2006, the disclosure of which is hereby incorporated herein by reference.

The present application is also related to the following co-pending and commonly assigned United States patent applications: 1) patent application Ser. No. 09/577,386 titled “NOVEL METHOD AND APPARATUS FOR REPRICING A REIMBURSEMENT CLAIM AGAINST A CONTRACT” filed May 23, 2000; 2) patent application Ser. No. 10/965,253 titled “INTERFACING DISPARATE SOFTWARE APPLICATIONS” filed Oct. 14, 2004; 3) patent application Ser. No. 10/923,539 titled “SYSTEM AND METHOD FOR MODELING TERMS OF A CONTRACT UNDER NEGOTIATION TO DETERMINE THEIR IMPACT ON A CONTRACTING PARTY” filed Aug. 2, 2004; and 4) patent application Ser. No. 11/213,996 titled “SYSTEM AND METHOD FOR DIRECTING PAYMENT OF A HEALTHCARE CONSUMER'S LIABILITY FROM A HEALTHCARE SPENDING ACCOUNT” filed Aug. 37, 2005, the disclosures of which are hereby incorporated herein by reference.

### NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The following description relates generally to processing of healthcare information, and certain portions of the description are related more particularly to systems and methods for estimating via a claim adjudication system, healthcare payment information, such as a consumer's liability, for a healthcare service without committing a claim for such healthcare service. Certain portions of the description are related generally to an enhanced claim adjudication system that is operable to selectively process received claim information for computing certain information (e.g., healthcare payment information) pertaining to the received claim information, without committing the claim information as an actual claim for reimbursement by an insurer.

### BACKGROUND

The third-party payer healthcare industry is a well-established industry. In general, in such third-party payer health care industry, a “third party” (referred to herein generally as an “insurer”) pays for healthcare services received from a service provider (any person, such as a doctor, nurse, dentist, optometrist, pharmacist, etc., or institution, such as a hospital, clinic, or medical equipment provider, that provides medical care, services, drugs, healthcare supplies, medical equipment, home health, etc.) to a member (or “insured”) consumer. As used herein, a healthcare consumer is any person to whom healthcare services are rendered. In some situations, the healthcare consumer may be referred to herein as a “patient”, but the services rendered are not limited to those rendered by a physician and thus “healthcare consumer” is not limited to a patient. The healthcare consumer may also be referred to herein as a “member” because the consumer is a member of one or more healthcare plans under which a third-party payer (insurer) pays for at least a portion of certain healthcare services rendered to the consumer.

Examples of third-party payers (or “insurers”) include an insurance company (e.g., BlueCross® BlueShield®, Aetna® Inc., etc.), Health Maintenance Organization (“HMO”), Preferred Provider Organization (“PPO”), third-party administrator (TPA), Self Insured/Self Funded Employer, or local, state, or Federal Government (e.g., Medicare) and their approved intermediaries including private insurers providing Medicare or Medicaid health insurance in coordination with, or on behalf of, the Government (e.g., BlueCross® BlueShield® of South Carolina provides and administers Medicaid and Medicare insurance), as examples. The insurers generally negotiate with the service providers (e.g., hospitals, doctors, etc.) various terms, including the amounts (and corresponding conditions) that the insurers will pay the service providers for services rendered to the consuming members of the insurers. For instance, a negotiated contract may specify that an insurer will pay a service provider X amount for performance of a given healthcare service (e.g., caesarean-section procedure, open heart surgery, blood test, routine physical exam, LASIK eye surgery, dental root canal, prescribed pharmaceuticals, healthcare equipment (e.g., wheelchair), etc.) for one of its members. The contract may specify those healthcare services for which the insurer will reimburse the service provider, as well as the corresponding reimbursement rates for each service. That is, the contract may define how the reimbursement is to be computed for each service. For instance, the contract may list things that are not covered and/or may specify that certain items are limited in the number of services that are allowed.

In view of the above, a complex relationship between consumers, service providers, and insurers exists, resulting in complexity in determining the respective liabilities of each party for a given healthcare service. For instance, depending on the consumer's healthcare plan with an insurer and the contract between the insurer and a service provider, the healthcare services covered, the amount covered, etc. may differ. For example, the liability for a given healthcare service rendered by a given service provider may vary from one consumer to the next depending on the consumers' respective healthcare plans. Further, the liability for a given service may vary from time to time for a given member, such as before the consumer's deductible has been satisfied versus after the consumer's deductible has been satisfied, etc. Because of the above-mentioned complex relationship, consumers and service providers traditionally fail to fully understand the financial impact to each party of a given healthcare service prior to the service being provided and a claim being submitted to the consumer's insurer. That is, the consumers and service providers traditionally fail to understand their respective liabilities under the consumer's healthcare plan for a given service until after the service is rendered to the consumer and a claim for reimbursement for such service is submitted by the service provider to the consumer's insurer. Once the service is provided and the claim is submitted, then a claim processing and adjudication system may be used to evaluate the claim tinder the insurer's contract with the service provider, etc. and determine the insurer's liability as well as the consumer's liability for such service. In general, claim adjudication refers to determination of liability of one or more parties (e.g., the patient/member, insurer, service provider, etc.) for a given healthcare service based on predefined relationships/responsibilities (e.g., the above-described contracts between the insurer and service provider and/or contracts between the member or member's employer, etc. and insurer). Such claim adjudication typically includes evaluation of the member's specific health benefit plan and status of their accumulators/financial accounts associated with their benefit plan to arrive at a determination of liability for the member/patient and/or insurer. Adjudication typically calculates patient liability based on such features as: 1) provider contracted rates/network benefit, 2) member's specific health benefit plan, 3) member's specific financial balances, accumulators, and accounts (deductibles, visits allowed/used, HRA, HSA, FSA, etc.), and 4) clinical edits for the member and their benefit plan. Traditional claim adjudication systems process received claims to adjudicate them (i.e., determine liability of the parties), and post/commit the adjudicated claim for payment by an insurer, in response to which funds are distributed from the insurer for the insurer's determined liability.

Many years of continued increases in medical costs have created an affordability crisis that is forcing many employers to discontinue medical coverage for employees or to reduce the level of benefits offered to employees. This trend essentially shifts an increasing amount of financial responsibility from the employer to the employee. Thus, it is increasingly important for the employee (healthcare service consumer) to understand the financial impact of desired medical services.

In view of the above trend, consumer-directed health plans are becoming an increasingly popular form of health insurance. In general, consumer-directed health plans combine financial incentives with information about cost and quality to help consumers make better informed decisions about their health care. In many cases, a consumer can establish a healthcare spending account which can be used for satisfying the consumer's obligation to a service provider. Such healthcare spending account is generally established in addition to the consumer obtaining health insurance from a third-party payer, and the healthcare spending account may be used for satisfying the consumer's obligations that are not an obligation of the third-party payer, such as the consumer's co-payment amount, deductible, liability for non-covered or not-allowed medical services under the member's benefit plan, etc. Various types of healthcare spending accounts have been developed, and further types may be developed in the future. Examples of known healthcare spending accounts include Archer Medical Savings Accounts (MSAs), Health Savings Accounts (HSAs), Health Flexible Spending Arrangements (FSAs), and Health Reimbursement Arrangements (HRAs). Each of these exemplary healthcare spending accounts are described briefly below.

In general, an Archer MSA is a tax-exempt trust or custodial account with a financial institution in which account holders can save money exclusively for future qualified medical expenses.

An HSA is a tax-exempt trust or custodial account created exclusively to pay for the qualified medical expenses of the account holder and his or her spouse or dependents. A person must be covered by a high-deductible health plan (HDHP) to be eligible for an HSA. The premium for a HDHP generally is less than the premium for traditional health care coverage, so the money saved on insurance premiums can therefore be put into the health savings account.

An FSA is a type of cafeteria plan authorized under section 125 of the Internal Revenue Code. Separate FSAs can be set up to cover each of the following types of expenses: 1) health insurance premiums (known as a “premium-only plan”); 2) qualified medical expenses; and 3) dependent care expenses. The FSA allows money to be deducted from an employee's paycheck pre-tax and then spent for qualified expenses tax-free. A drawback, however, is that the money must be spent within the calendar year. Any money left unspent at the end of the year is lost to the employee.

An HE is an employer funded account that reimburses employees for qualified medical care expenses, typically combined with an HDHP.

A common design for a consumer-directed health plan involves a high deductible health insurance policy, in many cases, a tax-exempt healthcare spending account that can be used to pay for qualified health care expenses, such as an HRA or HSA, and a gap between the deductible and the maximum allowable annual contribution to the account (that is, after the consumer has spent everything in his account, lie has to pay expenses out of pocket until he has satisfied the deductible). Funds may also be used for services that are not covered and therefore are not subject to the deductible limit.

The healthcare industry is one of the few industries where individuals receive services without knowing the cost in advance. Further, individuals are typically able to leave the office of the service provider without paying for the services, or even being aware of the amount of their liability for the services received. The consumer's liability for a service may include any payment for which the consumer is liable, which may include a co-payment amount under the consumer's healthcare plan, any unsatisfied deductible under the consumer's healthcare plan, any liability for services that are not covered by the consumer's healthcare plan, any coinsurance amount, etc. Traditionally, a consumer (e.g., member of a healthcare plan) schedules an appointment with a provider. The consumer may call his insurer to determine whether his deductible has been met, or how much of a deductible remains to be satisfied. The consumer may further verify with his insurer whether the service desired from a service provider is covered by the consumer's healthcare plan. Additionally, the consumer may verify the service provider's eligibility under the consumer's healthcare plan, such as in-network or out-of-network.

The service provider may likewise receive identification of the consumer's healthcare plan, and may contact the consumer's insurer to verify the service provider's eligibility, whether the desired procedure is covered by the healthcare plan, and the consumer's deductible amount. The information obtained would only reflect the plan's current view and would not necessarily be valid when the consumer actually receives the service from the service provider.

Depending on the specific terms of the consumer's healthcare plan, the consumer is typically liable for some amount of payment to the service provider, such as for the consumer's co-payment amount defined by the consumer's healthcare plan (e.g., the consumer may owe $15.00 for an office visit co-payment). Further, if the service obtained is not covered by the consumer's healthcare plan, if the service provider is not an eligible service provider under the consumer's healthcare plan, and/or if the consumer has an outstanding deductible that exceeds the billing amount, the consumer may be liable for a greater portion than expected and may even be liable for the service provider's full bill.

Traditionally, the service provider renders service to the consumer and then submits a claim to the consumer's insurer. Typically, the claim is a collection of provider and patient data, diagnosis, rendered services/procedures, correlated health-care items, with associated dates and a signed common procedure codes rolling up to a diagnosis code for a patient and the rendering provider; all of which may be used to create a bill for the health plan, generally referred to as the claim. As used herein, a “claim” refers to information about a healthcare service from which such information can be adjudicated to determine liability of one or more parties (e.g., patient, insurer, etc.) based on the above-mentioned pre-defined relationships/responsibilities. The claim is billed in expectation of payment from the health plan. Standard service provider billing forms are known, such as HCFA 1500 and UB92. Such claims may be submitted to the health plan directly or through a third party, resulting and payment, denial, request for information, and/or attachments such as explanation of benefits (EOB), explanation of payment (EOP), and sometimes electronic funds transfer (EFT) to the provider. The claim may, in some instances, be submitted electronically (e.g., via a communication network, such as the Internet) to the health plan or third party.

Traditionally, the liability of the consumer is not determined prior to provision of the desired care. Thus, the service provider and the consumer do not know the consumer's amount of liability for the care under the consumer's healthcare plan prior to the provision of the care. Given the above-mentioned complex relationship that often governs liability of the various parties, it is typically very difficult, if not impossible, for a service provider and consumer to understand an accurate liability of the various parties (e.g., consumer, insurer, etc.) prior to the desired care. Rather, after providing the care, the service provider typically collects the office visit co-payment (e.g., typically reflected on the consumer's insurance card) from the consumer, and submits (e.g., electronically) a claim for payment to the consumer's insurer based on services rendered, which is processed and adjudicated through an administration system to determine the responsibility of the insurer pursuant to the consumer's insurance policy. For instance, the submitted claim may be adjudicated through the insurer's claim system and committed for payment by an insurer of the insurer's determined liability; and thus in response to such adjudication, payment and EOB is provided to the service provider for the amount for which the insurer is liable (the “insurer's liability”), and a description of the line item to Niles, which often are translated to provider or consumer liabilities. The processing of the claim by the claim adjudication system typically results in payment, or denial (partial or full), requests for additional information, and/or attachments, and produces associated documentation, including the explanation of benefits (EOB), to provide payment details for the associated claim, including each service billed amount, the payer's allowed amounts, and disallowed amounts, and explanation or reason codes where needed. Other payer claims processing documentation includes FOP, EFT, etc. Some amount of consumer liability (i.e., “patient liability”) may remain outstanding, as described in the EOB, in which case the service provider then has to bill the consumer, creating an accounts receivable balance for the service provider. The consumer may then take money out of pocket, including cash, credit cards, healthcare financial accounts, etc. to pay this additional liability to the service provider. Because the consumer was unaware of the amount of such liability prior to the care, the amount of the consumer's liability may be surprising to the consumer and/or it may exceed their ability to pay, and thus it may be difficult and expensive for the service provider to attempt to collect the further amount from the consumer, resulting in delayed payment, billing and reconciliation expenses, collection fees, and potentially bad debt for the provider.

In some situations, basic eligibility and benefit checks may be conducted by a service provider to obtain an estimate of deductible and office visit co-payments prior to providing care to a patient. However, these estimates are often provided using outdated data that has been replicated for “lookups”, or use batch processing with standard EDI eligibility transactions (limited data available), and/or may require that the service provider place a telephone call, use limited Web portals, and/or fax a request and additional information to the insurer's customer service. These methods do not provide details to determine the entire patient liability amount. Traditional eligibility and benefit checks do not provide a detailed estimate of the patient's liability, including a real-time balance of deductibles, do not take into account the use of the patient's available financial accounts, and do not provide procedure-level patient-owed amounts. Wen such traditional eligibility and benefits checks are performed, the service provider does not receive the most up-to-date balances and detailed level of patient liability needed to accurately inform the patient and/or collect payment from the patient prior to delivery of care. Various systems that may be employed which attempt to estimate liability of various parties for a given service without performing adjudication of the information describing such service (e.g., to make the determination of liability based on the pre-defined relationships/responsibilities of the parties as of the time at which the estimate is desired), are not sufficiently accurate as to be reliable. For instance, a system that estimates the cost to a patient for a knee replacement procedure based on average costs to patients over the past 3 years fails to accurately adjudicate a claim for such procedure for the specific patient and his/her service provider taking into account the pre-defined relationships of the patient and service provider with an insurer, etc.

The consumer (patient) traditionally has even less information regarding their expected costs for the services than does the service provider. The consumer is traditionally limited to manual methods, such as calling their insurer and/or reviewing their healthcare plan's benefit summary, which does not include detailed procedure information and does not include service-specific estimates based on the specific care desired and the location and/or service provider that will actually render the care. In addition, the consumer is limited in their ability to receive an accurate estimate of their liability for specific procedures/services with specific providers, including comparison of the planned procedures/services across multiple providers to evaluate cost and quality of care to assist with making a decision about which provider they choose to provide the services.

Additionally, after rendering a service to a patient, an undesirably long delay is typically encountered while the claim is being submitted and processed by a claim adjudication system before the patient's liability for the service is accurately communicated to the service provider. For instance, most practice management systems that service providers employ for submitting claims generally operate on anywhere from several days (e.g., 4-5 day) to a 30-45 day cycle for returning claim liability information to the service provider. Thus, by the time that the service provider receives an accurate indication of the patient's liability for the service rendered, the patient has often left the service provider's office long ago, and thus the service provider is required to undergo separate billing and collection procedures (e.g., mailing invoices, etc. to the patient) in attempt to obtain satisfaction of the patient's liability. Service providers may often desire to have more timely and reliable understanding of the patient's liability for the service that was rendered such that the service provider can initiate billing and collection procedures earlier in the process (e.g., potentially even billing and collecting payment from the patient before the patient leaves the service provider's office).

Thus, a desire exists for improved techniques for obtaining information before care is rendered to a patient, as well as improved techniques for obtaining information and/or processing of claims after care is rendered to the patient.

### BRIEF SUMMARY OF THE INVENTION

Embodiments of the present invention provide enhanced systems and methods for processing of healthcare information. Certain embodiments of the present invention enable separation of claim adjudication for determining liability for identified services and posting/committing of such claim for payment of such determined liability. Traditional claim adjudication systems that were operable to adjudicate submitted claims for accurately determining liability of parties (e.g., insurer, consumer/member, etc.) based on pre-defined relationships/responsibilities automatically committed a claim for payment for the determined liabilities. As described above, such traditional claim adjudication systems were traditionally employed solely for retrospective submission and processing of claims for services previously rendered, and thus no desire for supporting adjudication of a claim for determining liability without committing such claim for payment of the determined liability was traditionally recognized. Embodiments of the present invention have recognized that supporting adjudication of a claim without presently committing such claim for payment of the determined liability may be beneficial in many instances. As one example, such feature may be employed to support prospective determination of liability for a service prior to such service being rendered. Other exemplary uses/benefits of such feature according to certain embodiments, including post-service usage thereof, are described further herein. As still another example, such feature may be employed to provide patient liability to meet new consumer healthcare requirements/desires, such as pricing transparency.

According to certain embodiments of the present invention, an enhanced claim processing system is operable to receive claim information (e.g., a submitted “mock” claim, as discussed further below), and selectively process the received claim information for computing certain information (e.g., healthcare payment information) pertaining to the received claim information, without committing the claim information as an actual claim for reimbursement by an insurer. Additionally, the enhanced claim processing system is operable to receive a submitted “actual” claim, adjudicate the claim, and commit the claim for reimbursement by an insurer, as is well known in the art. However, by providing an ability to selectively process received claim information to obtain/compute information (e.g., healthcare payment information) pertaining to such received claim without actually committing the claim, the claim processing system can be leveraged to provide various beneficial services, such as for providing reliable healthcare payment estimates, etc. For instance, as discussed further below, the claim processing system may be used to process a “mock” claim for services that have not yet been rendered to a patient in order to obtain an accurate estimate of the patient's liability for such services. In this way, the service provider, patient, and/or other authorized third party may have an accurate understanding of the patient's liability for a service before the service is rendered.

As another example, the claim processing system may be used to enable a service provider to submit a “mock” claim for services that have been rendered to a patient, wherein the claim processing system may process the mock claim and quickly (e.g., in real-time) return an accurate estimate of the patient's liability for such services. The service provider may then use the returned accurate estimate for initiating billing and collection procedures early in the process, such as prior to the patient leaving the service provider's office. In some instances, the service provider may use the returned accurate estimate to initiate billing and collection procedures for the patient's liability in parallel with the service provider's practice management system processing an actual claim for the services rendered, wherein the actual claim is processed to obtain reimbursement from the patient's insurer and the service provider is, in parallel (and, in some instances, even before submission of the actual claim for reimbursement from the insurer), billing and collecting from the patient the patient's liability.

Thus, as described further below, in one embodiment such an enhanced claim processing system is operable to receive a claim to be processed along with some indication (e.g., flag, etc.) that such claim is not to be committed as an actual claim. For instance, as discussed further herein, the enhanced claim processing system supports receipt of an actual claim (i.e., that does not contain an indicator that such claim is not to be committed), wherein the claim processing system processes such actual claim and commits the actual claim for reimbursement by an insurer, in a traditional manner. Additionally, in certain embodiments, the enhanced claim processing system supports receipt of a claim that has associated therewith some indicator (e.g., flag) that denotes that the claim is not to be committed as an actual claim (e.g., denotes the claim as a “mock” claim), wherein in response the claim processing system is operable to process the claim to obtain certain information pertaining thereto (e.g., healthcare payment information, such as the patient's liability) without committing the claim as an actual claim for reimbursement by an insurer.

In certain embodiments, an indicator may be associated with a submitted claim that specifies the claim is to be processed to determine a patient's liability and a full explanation of benefits (EOB), but not committed as an actual claim. In this manner, the patient's liability for the services identified in the submitted claim as of the time that the claim is being processed by the claim processing system is accurately determined and returned, without actually committing the claim for reimbursement by the patient's insurer. In certain embodiments, an indicator may be associated with a submitted claim to indicate a point in the claim processing system's flow of processing the claim at which such processing is to be interrupted. Thus, the claim processing system may support receipt of a claim that pre-specifies a point of interruption of the processing of such claim prior to committing the claim as an actual claim for reimbursement by an insurer.

In other embodiments, the indicator may be associated with a submitted claim to indicate that the transaction of processing the claim is to be rolled back. In other words, in certain embodiments, the claim processing system may fully process the received claim and commit it as an actual claim for reimbursement by an insurer, but then, based on the indicator associated with the received claim, rollback the transaction so as to uncommit the claim. Transaction processing system's have long supported such a rollback operation to uncommit a transaction. However, rollback operations are often performed in response to a decision that is made after an initial request for performing the transaction, e.g., in response to detection of an error in the initial request, or a decision not to perform the initial request is made after submission of the initial request, etc. In certain embodiments of the present invention, a claim (e.g., “mock” claim) is submitted to a claim processing system with an indicator associated therewith that pre-specifies the claim as one that is to be processed and not committed (e.g., is to have its transaction rolled back so as to uncommit the claim).

In still other embodiments, the “mock” claim may be directed to (e.g., based on the associated indicator identifying it as a “mock” claim) adjudication logic that does not include commit functionality. Thus, for instance, adjudication logic may be implemented that receives a claim and adjudicates the claim to determine liability of the parties (based on their pre-defined relationships/responsibilities), wherein such adjudication logic does not include commit operability. In this manner, the claim can be adjudicated to accurately determine liability of one or more parties for the service identified in the claim without committing the claim for payment of the determined liability.

While many examples are provided herein that focus on processing a received mock claim for obtaining healthcare payment information without committing the mock claim as an actual claim for reimbursement by an insurer, such a received mock claim may, in certain embodiments, be processed to obtain other information pertaining to the mock claim instead of or in addition to the payment information. For instance, an indicator may be associated with a received mock claim that requests the claim processing system to interrupt its processing of the claim after verifying the service provider and/or patient eligibility but before computing the patient's liability.

According to one embodiment of the present invention, a method comprises receiving, at a claim processing system that is operable to adjudicate a claim for payment from an insurer for services rendered to a healthcare consumer, a request for estimated healthcare payment information for a service. The service may be a service that has not yet been rendered to the healthcare consumer. According to embodiments of the present invention, the request for the estimated healthcare information may be received (e.g., electronically, such as via a web interface, and/or otherwise via a communication network, such as the Internet) from the healthcare consumer or from a healthcare service provider, as examples. The method further comprises processing the request by the claim processing system for determining the requested estimated healthcare payment information. The method further comprises communicating, from the claim processing system, a response to the request that includes the estimated healthcare payment information.

In this manner, a claim processing system is operable to provide accurate estimated healthcare payment information, such as the healthcare consumer's liability for the service. As described further herein, in certain embodiments, the claim processing system adjudicates the request for estimated healthcare information substantially as it would an actual claim submitted for the service, without committing the claim. Thus, the “estimated” healthcare information is accurate for the healthcare services included in the request for estimate as of the time that the request is submitted/processed by the claim processing system, according to certain embodiments. As such, while the returned information (e.g., the healthcare consumer's liability, etc.) is referred to herein as an “estimate”, according to certain embodiments, the returned information is an accurate representation of what the claim processing system would return in response to an actual claim (e.g., a claim that would be committed) submitted for the services included in the request for estimate (e.g., the “mock” claim described below) as of the time that the request is submitted/processed.

In certain embodiments, the healthcare payment information pertains to a specific healthcare service for a specific healthcare consumer, and the requested for estimated healthcare information is received by the claim processing system before the service is rendered to the healthcare consumer. Accordingly, the claim processing system may provide an accurate estimate of healthcare information pertaining to the specific healthcare service for a specific healthcare consumer, such as the consumer's liability for specific service, before the service is rendered to the consumer. In this way, the consumer and/or service provider may receive accurately estimated information concerning the specific service, which may aid the consumer and/or provider in properly evaluating the impact of receiving such service. However, as mentioned above, in certain instances the mock claim may be submitted to request payment information pertaining to specific healthcare service for a specific healthcare consumer after such services have been rendered.

In certain embodiments, the request for estimated healthcare information comprises a “mock” claim for the service that has not been rendered to the healthcare consumer. According to certain embodiments, the “mock” claim is substantially the same as an actual claim that is received by the claim adjudication system, but the “mock” claim is not committed/posted by the claim adjudication system. Thus, the claim adjudication system can process the mock claim just as an actual claim in order to obtain healthcare information pertaining to such mock claim (e.g., the consumer's liability for the services identified in the mock claim, etc.), but the claim adjudication system does not actually commit the claim for payment by an insurer. According to certain embodiments, the mock claim contains an indicator that indicates to the claim processing system that the adjudicated claim should not presently be committed/posted, as would an actual claim for a service that has been rendered to the consumer. The mock claim may be in a common format as an actual claim for a service that has been rendered to the healthcare consumer, and is adjudicated by the claim processing system substantially as would an actual claim, except for being committed/posted. For example, according to certain embodiments of the present invention, a common user interface may be used for inputting information for either a “mock” claim or an actual claim. Once the information is input, the user can either submit the information as an actual claim (e.g., using a “submit claim” button on the user interface) or can submit the information as a mock claim (e.g., using a “request estimate” button on the user interface) to obtain an estimate of the healthcare information pertaining to the claim, such as the consumer's liability, FOB, etc. In this manner, the ability to request an estimate of healthcare payment information (e.g., submit a mock claim) may be implemented within the familiar user interface utilized for submitting actual claims for services rendered, thereby enabling easy adoption and utilization of certain embodiments of the present invention by healthcare providers. Further, according to certain embodiments, the common interface may further improve efficiency by permitting a previously submitted mock claim to be recalled and re-submitted (either unmodified or modified in some way, such as to include additional services that may have been rendered that were not included in the mock claim) as an actual claim to the claims processing system.

Thus, the claim processing system may return much of the information that would be returned if the mock claim were submitted as an actual claim. For example, in certain embodiments, the returned estimated information may include an explanation of benefits. Further, in certain embodiments, any information (or lack thereof) contained in the mock claim which would result in an error being returned by the claim processing system if the mock claim were an actual claim may likewise result in a return of such an error. As such, the information and/or formatting of the claim can be corrected when it is being submitted as a mock claim.

Further, according to certain embodiments of the present invention, the mock claim and/or an actual claim may be processed by the claims processing information for returning the corresponding estimate or actual healthcare payment information, respectively, in a suitably efficient manner. For instance, according to certain embodiments, the claims are processed so as to return the corresponding healthcare information sufficiently quickly as to permit financial settlement to be performed at the point of check-out of a healthcare service provider. Accordingly, certain embodiments of the present invention, enable the rendering of healthcare services and financial settlement for payment for such services to be transacted much like other traditional retail transactions, wherein a consumer of the services (e.g., patient) can be accurately informed as to the payment information, such as the consumer's liability, prior to receiving the services (e.g., through the submission of a mock claim) and an claim for the actual services can be processed to post the actual claim for the services rendered to enable the consumer to be billed and arrange payment for his/her liability for the claim at the time of check out. As described further herein, embodiments of the present invention may be employed for obtaining an accurate estimate of healthcare payment information for healthcare services by a healthcare provider (e.g., using the above-mentioned claim submission interface), by a healthcare consumer (e.g., using a web or other suitable user interface), and/or other suitable parties. Further, as described further herein, embodiments of the present invention may be utilized at various points in time relative to the rendering of healthcare services to a consumer, including prior to rendering of service (e.g., by submitting a mock claim to obtain estimated healthcare payment information for one or more healthcare services that are under consideration for the consumer), at the point of rendering service to the consumer (e.g., while the consumer is at a provider's office or a hospital for receiving treatment), and/or at a time following the rendering of a service to a consumer (e.g., either before or after the consumer leaves the provider's office or hospital), as examples.

According to certain embodiments of the present invention, a method comprises receiving, at a claim processing system that is operable to adjudicate a claim for payment from an insurer to a service provider for services rendered to a healthcare consumer, a mock claim for a service. In some instances, the service may be a service that has not yet been rendered to the healthcare consumer. Again, such mock claim may be in a common format as an actual claim for a service that has been rendered to the healthcare consumer with an indicator (e.g., flag) that indicates that the is not to be committed/posted by the claim processing system. The method further comprises processing the mock claim by claim adjudication logic of the claim processing system to determine an estimate of healthcare payment information for the service. Again, such estimate of healthcare payment information may include such information as the consumer's liability for the service and an explanation of benefits, for example. The method further comprises outputting, from the claim processing system, the estimated healthcare payment information for the service. Such outputting may comprise electronically communicating the estimated healthcare payment information to the consumer, a healthcare service provider, and/or other authorized party, via a communication network, such as the Internet.

According to certain embodiments, a method comprises receiving, at a claim processing system that is operable to adjudicate a claim for payment from an insurer to a service provider for services rendered to a healthcare consumer, a request for real-time processing of healthcare payment information. Such real-time processing of healthcare information is generally distinguished from over-night batch processing of claims, wherein claims processed in such real-time generally return healthcare payment information in sufficient time to enable financial settlement at the point of check-out, such as within one hour and in typical embodiments substantially faster than that (e.g., on the order of a few minutes). The method further comprises processing the request by the claim processing system for obtaining at least a portion of requested healthcare payment information, and communicating, from the claim processing system, a response to the request that includes the requested healthcare payment information in real-time.

According to certain embodiments of the present invention, a system comprises adjudication logic that is operable to adjudicate a claim for payment from an insurer to a service provider for services rendered to a healthcare consumer. The system further comprises an interface to the adjudication logic that enables receipt by the adjudication logic of a mock claim for a service, wherein the mock claim is not to be presently committed by the adjudication logic for reimbursement by an insurer. The service(s) included in the mock claim may be service(s) that have not been rendered to the healthcare consumer. The adjudication logic is operable to process the mock claim to determine an estimate of healthcare payment information for the service. In this manner, the adjudication logic may process the mock claim substantially as it would an actual claim, but does not commit the mock claim. In certain embodiments, the system further comprises an interface to the adjudication logic that enables receipt by the adjudication logic of a request to commit the mock claim. For example, a received mock claim may later be converted to an actual claim that is committed by the adjudication logic.

According to certain embodiments, a system comprises adjudication logic that is operable to adjudicate a claim for payment from an insurer to a service provider for services rendered to a healthcare consumer. The system further comprises an interface to the adjudication logic that enables receipt by the adjudication logic of a request for real-time processing of a claim for determining healthcare payment information for the claim. The adjudication logic is operable to process the claim to determine the healthcare payment information for the claim and communicate, in real-time, a response to the request that includes the determined healthcare payment information.

Certain embodiments enable real-time processing of information, such as claim data, to enable various improvements to pre-service and/or post-service processing of information. Thus, certain embodiments offer various improvements along the end-to-end flow of providing healthcare service to consumers. For instance, various improvements to the pre-service processing of information are provided by certain embodiments. That is, embodiments of the present invention enable improved processing of information before (or at the point of) healthcare service being rendered to a consumer. As described further herein, in certain embodiments various improvements are provided to a healthcare consumer before the healthcare consumer receives healthcare service from a service provider. Further, in certain embodiments, various improvements are provided to a healthcare service provider before the service provider renders healthcare service to a consumer.

Further, various improvements to the post-service processing of information are provided by certain embodiments. That is, embodiments of the present invention enable improved processing of information after healthcare service is rendered to a consumer. As described further herein, in certain embodiments various improvements are provided to a healthcare consumer after the healthcare consumer receives healthcare service from a service provider. Further, in certain embodiments, various improvements are provided to a healthcare service provider after the service provider renders healthcare service to a consumer, such as real-time processing of a claim for the service to enable reconciliation of the patient's liability before the patient leaves the service provider's office, thereby enabling the payment for healthcare services to be transacted much like traditional retail transactions with which consumers are very familiar (e.g., in purchasing a shirt from a clothing retailer, a consumer generally selects the desired shirt, is informed of the price to the consumer for purchasing the shirt (e.g., from a price tag on the shirt), and pays for the shirt prior to departing the retailer with the shirt).

As mentioned above (and as described further below), certain embodiments provide various improvements to processing of information for a healthcare consumer before the healthcare consumer receives healthcare service from a service provider. For instance, certain embodiments enable a consumer to request information (e.g., via a website or other user interface) pertaining to a specific service. Embodiments are provided that enable a healthcare consumer to obtain information pertaining to a specific healthcare service such as an accurate estimate of the consumer's liability for the service, an indication of eligibility of a service provider, and/or other information to aid the consumer in understanding the impact of receiving the service. Certain embodiments enable a consumer to obtain information to aid the consumer in intelligently selecting a service provider, a service (e.g., which medical procedure), etc. that is best to select under the consumer's healthcare plan. For instance, quality ratings of various eligible service providers may be provided, as well as an indication of the corresponding consumer liability for each service provider, and various alternative or complementary services may be identified along with the corresponding consumer liability for each such service. In this way, the consumer is provided sufficient information to make intelligent choices in managing his/her healthcare under his/her healthcare plan.

As mentioned above (and as described further below), certain embodiments provide various improvements to processing of information for a healthcare service provider before the service provider renders healthcare service to a consumer. For instance, certain embodiments enable a service provider to request information (e.g., via a website or other user interface) pertaining to a specific, service. Embodiments are provided that enable a healthcare service provider to obtain information pertaining to a specific healthcare service that is to be rendered, such as an accurate estimate of the consumer's liability for the service, an indication of eligibility of the service provider, the consumer's personal health record, and/or other information to aid the service provider in understanding the impact of rendering the service.

As mentioned above (and as described further below), certain embodiments provide various improvements to processing of information for a healthcare consumer after the healthcare consumer receives healthcare service from a service provider. For instance, certain embodiments enable a consumer to request information (e.g., via a website or other user interface) pertaining to a specific service that was rendered to the consumer. Embodiments are provided that enable a healthcare consumer to obtain information pertaining to a specific healthcare service, such as an FOB, an explanation of differences between the post-service EOB and any pre-service EOB provided to the healthcare consumer (e.g., explaining differences, if any, between a pre-service estimate of patient liability and post-service determination of actual patient liability), and/or other information about the service.

As mentioned above (and as described further below), certain embodiments provide various improvements to processing of information for a healthcare service provider after the service provider renders healthcare service to a consumer. For instance, embodiments are provided that enable a healthcare service provider to efficiently submit a claim for the service for processing in real-time, as opposed to waiting for nightly batch processing. This may enable the service provider to reconcile the patient's liability (e.g., receive payment from the patient for the patient's liability amount) before the patient leaves the service provider's office. As described above, a service provider may, at the point of check-out, submit a mock claim to the enhanced claim processing system for the services rendered to the healthcare consumer, wherein the claim processing system returns an accurate estimate of the patient's liability for such services without committing the claim as an actual claim. Thus, the service provider can quickly initiate billing and collection procedures for the patient's liability, if so desired. The mock claim may then be converted to an actual claim to be committed for reimbursement by an insurer (for payment of the insurer's liability), or if the service provider has some other pre-existing workflow for submitting actual claims (e.g., through a practice management system, etc.), such other pre-existing workflow may be employed to submit the actual claim for reimbursement by an insurer (to obtain payment of the insurer's liability). In this way, the service provider may submit the “mock” claim to quickly obtain an accurate indication of the patient's liability, without interrupting/disturbing whatever workflow the service provider desires to use for submitting an actual claim for reimbursement by an insurer.

Thus, as described further herein, embodiments are provided that enable enhanced pre-service and/or post-service processing of healthcare information for healthcare consumers and/or service providers. As described further below, certain embodiments enable pre-service processing of healthcare information, wherein a healthcare consumer (e.g., patient), a service provider (e.g., physician), and/or other parties can obtain accurate information pertaining to a specific service, such as an accurate estimate of the healthcare consumer's liability for the service under their healthcare plan, etc. In certain embodiments, the information obtained includes benefits (e.g., EOB) and liability information pertaining to the specific service. As described further herein, the specific service may include one or more healthcare services to be rendered by one or more specified service providers. The healthcare consumer's liability may be accurately estimated for the specific service to be rendered by the selected service provider(s) based on such factors as a quality score of the service provider, cost of care, etc. Also, as described below, in certain embodiments, post-service (after delivery of care) processing of healthcare information is enhanced. For instance, claim submission, processing, adjudication, and reconciliation of outstanding liability of a healthcare consumer after provision of a service are enhanced (e.g., efficiency is improved) in certain embodiments.

As further described herein, certain embodiments enable real-time processing of claims (whether “mock” claims for obtaining an estimated liability or whether actual claims submitted and posted in real-time at the point of service), as opposed to traditional overnight batch processing of claims with any errors returned the following day, after the patient has checked-out or been discharged. Thus, for instance, when the patient arrives at a service provider's office (e.g., prior to provision of the service), the service provider is able to submit an estimated liability request, based on the service expected to be rendered, and a mock claim is created and submitted to an administration system. In certain embodiments, the mock claim is submitted as if it were a real claim, but includes a flag to indicate to the processing system that the claim is not to be actually posted/paid (i.e., not committed by the processing system). That is, in certain embodiments, the service provider supplied information just as with an actual claim and clicks on a button on the user interface to request an estimate of liability, and in response the claim is submitted to the claim processing system as a mock claim (with a flag indicating that the claim is not to actually be posted). This enables the health plan to “adjudicate” the claim without posting the claim (e.g., interrupting processing of the claim prior to committing it, or rolling back such committing of the claim), and process the estimated liability request as if it were the actual claim, resulting in an adjudicated claim, and return of the real-time explanation of benefits (EOB), including the real-time accurate patient's liability, as if the claim had been posted. The provider can then inform the patient of the accurate liability (as of the point when the request was made), and/or collect some or all payment prior to actually rendering the service. This new process can be used at time of scheduling, and followed up for accuracy and latest balances at time of check in, and can be used to post the claim in real-time at time of check out. In certain embodiments, the claim submission/adjudication/response process can be used for both the estimated liability and the claim submission/posting processes, providing accurate, up-to-date information at time of request/posting, and can be available to both the provider and the patient to receive the same results from the health plan.

As a further example, after providing service to a patient but before the patient departs the service provider's office, an actual claim can be submitted to the administration system, which processes the claim and returns an amount of actual liability of the patient, whereby the service provider can collect payment for the service before the patient leaves the service provider's office. Various other aspects of the exemplary embodiments are described further herein.

Certain embodiments enable information pertaining to a specific healthcare service to be rendered at the point of service (“POS”) either prior to or after care is rendered. For instance, a physician may, according to embodiments of the present invention, obtain estimates and/or other information relating to a specific service to be rendered, and/or submit a claim for processing in real-time at the POS (i.e., before the patient leaves the physician's office), either before or after the physician renders care to the patient. Certain embodiments enable a service provider, healthcare consumer, or other party to obtain service-specific information, such as an estimate of the healthcare consumer's liability for a specific service, prior to the rendering of the actual care, which is referred to herein as “pre-service” or “pre-care”. The care provided by a service provider may be referred to herein as “service” or “care”, and may include one or more procedures, examinations, consultations, treatments, provision of drugs, provision of healthcare equipment, etc.

Traditionally, many providers' pre-patient care/visit financial planning activities rely heavily on the eligibility verification process (representative of the more sophisticated providers, with large billing amounts and volumes, and/or multi-physician group practices, specialists, hospitals, their physician affiliates, etc.). Provider's using the eligibility verification process typically check the member's eligibility for health benefits, and the provider receives limited patient/member eligibility and benefits information from the insurance carrier or other third parties. This limited eligibility and benefits information typically includes the member's status of enrollment in the plan (i.e., covered by insurance yes/no). Some insurers and third parties provide the deductible balance and co-payment amount for office visits. Various issues with this transaction/process are described further below. Even when this level of data is made available to the provider prior to the member's care, the provider's access to these variables are only part of the overall patient liability calculation, and will not provide a total view of the patient's liability amount, The provider must also consider other things that may impact the liability, such as the member's most recent/current financial balances including deductible, and the applicable financial accounts at the time the member checks in and/or receives service. The patient liability calculation should also take into consideration the member's liability at the line item procedure level, and all services provided for the total visit, which is more representative of a provider bill or ‘claim’, versus the traditional use of a high level eligibility and benefit verification.

According to certain embodiments of the present invention, the traditional process used by providers and members for pre-visit eligibility and benefit verification are transformed to a new method, supported by enhanced solutions, to meet the needs of providers and members to manage complex benefit plans, where consumers bear increasing financial responsibility (including consumer directed, high deductible, individual, etc.). Transformation to these processes and tools enables resolution of inaccurate and inefficient processes which impact financial, administrative and medical costs in the industry. Additionally, consumers will increasingly be unable to bear most of the cost of healthcare, resulting in a breakdown in the healthcare system, and the supporting supply chain with financial impacts to all parties involved including private industry, consumers, and government. Thus, as described further herein, embodiments of the present invention provide techniques for accurately computing patient liability in real-time to, for example, determine an accurate estimate of the patient's liability before rendering service and/or to complete a payment transaction for the patient's liability at the point of service (e.g., before the patient departs the service provider's office).

As mentioned above, a consumer may obtain certain information about their healthcare plan, such as their deductible balance and co-payment amount by contacting their insurer via telephone, fax, and/or a website offered by the insurer. However, the consumer's desire for information about their full liability for a service often exceeds the deductible and office visit co-payment amount of their healthcare plan. Further, the information about their deductible balance, etc. may be outdated. The service provider likewise shares a desire for an accurate estimation of a consumer's liability. To obtain an accurate estimation, more than an indication of the consumer's deductible and co-payment amounts under their healthcare plans may be taken into consideration. For example, an understanding of the broad liability calculation may be evaluated to arrive at an accurate amount owed by the consumer for the service. This may require determining liability based on the specific consumer's benefits under their respective healthcare plan, primary and secondary insurance, planned procedures and/or service types, which provider they are visiting, and how their financial accounts, if any, are integrated into the calculation. Traditionally, consumers have not had tools to access their total liability amount for a specific provider, and costs related to specific procedures or episodes of care, and determine what financial accounts could be used for payment, and balances of those accounts, etc.

Further, in the evolving consumer environment, much like the consumer, the service provider has a growing desire to determine the total and accurate patient liability. Further, it is desirable to obtain a line item procedure/service level member co-payments, balances of deductibles, balances of financial accounts where appropriate, for automatic access to draw from those accounts, resulting in the ability to collect the amount owed from the consumer prior to the consumer's check-out/discharge.

Certain embodiments of the present invention provide systems and methods for pre-service processing of healthcare information. That is, systems and methods are provided that enable information pertaining to a specific healthcare service (e.g., a specific medical procedure, examination, treatment, etc.) that is to be rendered to a member of a healthcare plan to be obtained and presented to the member, service provider, and/or other parties at or before the point of care. For example, certain embodiments of the present invention enable pre-service processing of an expected claim for a desired healthcare service to enable a service provider (e.g., doctor), healthcare plan member (e.g., patient), and/or other parties to obtain information about the expected claim, such as an estimation of the member's liability for the service under the member's healthcare plan.

For instance, suppose a healthcare plan member desires to obtain certain healthcare services from a service provider, such as medical treatment for an illness, a physical examination, etc. Prior to receiving such service, the member and/or the service provider may submit information to an administration system (e.g., via a website or other interface) identifying the service (e.g., the planned procedures, etc.) and may request from the administration system an estimated liability explanation. The administration system may generate a “mock” claim for the desired service to a processing system, whereby the processing system evaluates the submitted mock claim, pre-processes and adjudicates the claim, and returns information about the service (e.g., at a procedure (line item) level and/or at a claim level) under the member's healthcare plan, such as an estimation of the member's liability (i.e., patient liability) for the service under the member's healthcare plan, provider allowed amount, and healthcare plan financial liability, as examples.

Various information (which may be configurable for the member) pertaining to the specific planned services may be provided under embodiments of the present invention, including without limitation an estimate of the member's liability for the service, an indication of the service provider's eligibility under the member's healthcare plan, a summary of the member's benefits under the healthcare plan (e.g., an identification of healthcare services or procedures covered by the member's benefit plan, an identification of formularies (drugs) covered by the member's benefit plan, etc.), and the member's personal healthcare record(s). In certain embodiments, the service-specific information may also include financial information for the member, such as the member's credit score (or credit rating), identification of the member's healthcare financial accounts that are available (e.g., HSA, FSA, HRA, ESA, etc.), and their respective available balances, etc. In certain embodiments, the administration system may return an offer to the member for a line of credit, or offer a debit card that deducts monies from a healthcare spending account, etc. In certain embodiments, an Accountable Health Statement may be provided to the member, which provides a personalized statement for the member's healthcare-related financial status (e.g., outstanding deductible, healthcare spending accounts, etc.). In certain embodiments, Personal Care Advance (PCA) may be provided, which may automatically generate reminders to the member (e.g., based on the member's personal health record) to schedule a visit to a service provider (e.g., for an examination, treatment, etc.) or otherwise perform some needed healthcare service (e.g., refill a prescription, etc.).

Further, in certain embodiments, the information returned may include evaluation across multiple providers for services including cost for specific procedures, quality ratings and/or other information about the service provider under evaluation, and/or an identification of alternative service providers that may be used under the member's healthcare plan with their corresponding quality ratings and/or estimated patient liability, etc. The administration system may, in certain embodiments, allow the member to receive “bids” from eligible service providers (e.g., approved by the healthcare plan) for cost of specific procedures of episodes of care. Additionally, the information returned may, in certain embodiments, include identification of other alternative or complimentary healthcare services that may be considered instead of or in addition to the specific service under evaluation, along with the corresponding estimated liability and other information for such alternative or complimentary healthcare service. Further still, in certain embodiments, the administration system may enable a user (e.g., patient) to purchase durable medical equipment, supplies, and other supporting products and retail services for end-to-end management of the user's episode of care/treatment, and ongoing management.

One or more of the above-mentioned items of information may be provided pre-service to a requesting healthcare consumer (patient), a requesting service provider, and/or other authorized parties. For instance, in one embodiment, a healthcare consumer may log onto a website and obtain the above-mentioned information prior to scheduling and/or receiving a desired service. Thus, the healthcare consumer can become very informed as to the healthcare consumer's estimated liability for the service, as well as other details pertaining to the service. Similarly, in one embodiment, the service provider may access the administration system (e.g., via logging onto a website, via their PMS, or via another channel of access) and obtain the above-mentioned information prior to rendering service to a healthcare consumer (patient). In certain embodiments, access to the information may be supported via a plurality of different channels, such as web site access, integration with the service provider's PMS, system-to-system access, EDI access, etc. In certain embodiments, such a request for information from the administration system may be triggered automatically by the service provider upon scheduling of an appointment with a patient. In certain embodiments, financial information may be pushed to a Quicken™ or other financial application on the service provider's and/or consumer's computer system. Also, in certain embodiments, the consumer's personal health record (PHR) may be pushed from the administration system to the service provider and/or consumer.

It should be recognized that in certain embodiments the information obtained is specific to the healthcare service expected to be rendered. That is, the information is specific for a given member with a given healthcare plan, the given service provider to render the service, the given service to be rendered, etc. Thus, such “service-specific” information can be obtained, which provides accurate details about the specific service in question, such as an estimated member liability for the specific service to be rendered by the specific service provider under the member's healthcare plan. In this manner, the knowledge of the member, service provider, and/or other parties regarding the service as it pertains specifically to the member and service provider in question under the member's healthcare plan is enhanced. In other words, as described further herein, the member, service provider, and/or other parties can beneficially gain information about the service before or at the point of service.

Depending on the type of service provider (e.g., inpatient, outpatient, physician office, ambulatory, etc.), various methods may be used to calculate the patient, provider, and payer liability, including procedure level evaluation (mock or actual claim), contract-based estimates, average type of service for hospital/inpatient stays-episodes, and evaluation of claim history for overall episode of care to include average estimates for all types of services typically needed when treating a specific diagnosis or specific type of service (e.g., knee replacement, including inpatient surgery plus number of outpatient physical therapy visits, or standard maternity with average X day inpatient stay and Y number of follow-up visits).

As described further herein, in certain embodiments, a claim processing system (or “claim adjudication system”), such as the claim processing system commercially known as FACETS® available from The TriZetto Group, Inc., is utilized for collecting procedure and service level information to create and process a mock claim used to perform the adjudication function without actually posting (i.e., committing) the claim; and determine a member's estimated liability and the service provider's allowed/payment amount. Thus, in certain embodiments, the estimated liability is very accurate for the mock claim. Indeed, in certain embodiments, the estimated liability will correspond to the actual liability of the actual claim to the extent that the mock claim accurately reflects the actual claim (e.g., to the extent that the actual services rendered are only those expected to be rendered) and to the extent that the member's status has not changed (e.g., that the member does not have intervening claims (between the time of processing the mock claim and processing the actual claim) that may affect the member's outstanding deductible balance, etc.). Further, any errors or problems with the submission of the mock claim can be determined. For instance, if the service provider includes an incorrect procedure code or otherwise unacceptable information in the mock claim, the claim processing system can return an error to the service provider. In this way, the service provider can ensure that the mock claim is in the correct form for processing by the claim processing system, which may ease the process of submitting the actual claim later (e.g., after the service is rendered). In certain embodiments, the mock claim may be saved and simply re-submitted as an actual claim to be committed by the adjudication system (e.g., after the service is rendered). In certain embodiments, a “submit” button or other user interface may be provided to enable the service provider (and/or their practice management system (PMS), clearinghouse, or billing service) to easily re-submit a mock claim as an actual claim to the claim processing system for actual processing and committing of the claim, rather than for obtaining the pre-service information, such as estimated member liability, etc.

It should be recognized that using an actual back-end claims processing system (such as is used for processing and adjudicating actual claims) for estimating consumer liability provides a much more accurate and detailed result then does a separate system that attempts to replicate a claims processing system. Further, this saves the health plan and service provider from purchasing additional software and maintaining it, as well as becoming familiar with how to use it. Additionally, such an enhanced claim processing system that supports processing of a mock claim in the manner described further herein can be utilized to obtain accurate estimated information pertaining to the mock claim without interrupting the workflow for submitting an actual claim, as mentioned above.

Certain embodiments provide enhanced systems and methods for post-service processing of healthcare information. As mentioned above, in certain embodiments, a mock claim that is processed pre-service can be used for re-submission as an actual claim post-service. Thus, a pre-processed mock claim can be saved and re-submitted as an actual claim, which may ease the post-service claim submission process.

In certain embodiments, the service provider can recall (from previous estimates, if applicable) the request for liability based on procedure/claim-level data. The service provider can then make any updates to such recalled request, and submit the claim for processing, adjudication, and final posting (i.e., committing). In one embodiment, the service provider can do this using their web browser or through their PMS or other parties, and the use of the “claim retrieval and posting” option—which is pre-integrated between the service provider and payer systems. The service provider may submit the claim in real-time prior to member check-out (where the service provider is able to collect accurate patient liability, either in full, through a payment plan, lines of credit, or through other various financial account options). The service provider receives explanation of payment (EOP), and actual payment from the payer (insurer) using any of various methods, such as check, automated deposits, and standard EST transactions/transfers. The service provider also receives EOP at detailed level from payment, and this is consistent with the member's EOP. All of this may be triggered by the adjudicated and posted bill, and the member's post-care payment/financial transactions that can alter the provider's payment depending on where the member's financial account exists. In certain embodiments, payment plans and financial payment selections by the member with the healthcare plan are communicated to the service provider via standard transactions and through their configurable options, such as browser, EDI, or system-to-system update and posting. The service provider may create the patient bill based on the healthcare plan explanation of benefits, and payment data and amounts.

According certain embodiments, a new process is introduced to patients/health plan members, which improves from a manual process (e.g., manual telephone calls to service providers and/or payers) to automation and real-time data. According to one embodiment, the member receives a bill from the service provider after the service provider renders service. The member also has access (e.g., via the Internet) to online explanation of benefits (EOB) from the payer (insurer) to assist with reconciliation by providing detailed explanation of what was paid, what the patient owes (e.g., their deductible and co-pay, and line item procedure payment data). The patient's liability amount may be calculated utilizing available funds/accounts. In certain embodiments, the member (patient) may be offered lines of credit, accounts available that can be used to pay, and ability to pay online using these various accounts and credit options, their own credit card, and/or sign up for a line of credit based on their credit rating and financial needs. The member can make payment selections/options online, and the payment will post to the payer or service provider, depending on the type of account used, with assistance of banking and third-party relationships, and in conjunction with the service provider and health plan to coordinate payment reconciliation and post-treatment payment plans and financial methods. In certain embodiments, members are provided retail options to purchase durable medical equipment, drugs, and other products/services associated with their ongoing treatment plan and follow-up care recommendations. Information about what is covered, not covered, and a patient liability is provided for these items for health plan sponsored suppliers, networks, etc. Out of network suppliers for these items may be quoted as well. Recommended sources for these purchases may be communicated from the health plan to the service provider to assist the service provider with communicating, options to the member/patient as they leave the provider's office and pursue retail purchases to continue their treatment at home and ongoing.

Further, in certain embodiments, real-time claim submission is supported. That is, a mock claim and/or an actual claim can be submitted and processed individually in real-time, as opposed to traditional nightly processing of a day's claims in batch. The corresponding member liability for a mock claim or an actual claim can be recalled, re-submitted, and even posted/determined in real-time claims adjudication. Both the service provider and the member can receive explanations of gaps between the quoted estimated liability, subsequent estimated liability, and final estimated liability (all estimated liability are using the “mock” claim submit and adjudicate process mentioned above). In certain embodiments, the service provider also has an option to submit and post the final claim using accessed history of requested liability estimates that are maintained by the administration system.

In certain embodiments a service oriented architecture (SOA) is used for implementing a system for supporting the above-described pre-service and/or post-service processing. In certain embodiments the architecture provides various advantages, such as runtime configurability of the administration system, as described further herein. In certain embodiments, the SOA implements an Enterprise Transaction Manager (ETM), as described further herein. The various business functions described herein are “services” in SOA terminology. The ETM enables business users to orchestrate these services into a real-time POS business process that is unique to the health plan and provides competitive advantage. The ETM can invoke services from multiple systems, which has 2 underlying implications. First, services can reside in different systems because the payer has implemented a best of breed approach to system implementation. Therefore, many different software components are used within a single payer to provide the services (business functions) used in the real-time POS. Second, services are provided by multiple payers. The ETM can deliver access to multiple payers to the provider. Further, the ETM facilitates multiple channels of access from the provider perspective, including without limitation web-based connectivity, PMS connectivity, HIS connectivity, and IVR connectivity.

According to certain embodiments of the present invention, a “disruptive” process is provided that enables a change as to how providers, members, payers, and 3rd party vendors process information for estimating a patient's liability. This provides additional capabilities beyond the traditional eligibility/benefits transaction. According to one implementation, the liability amount is desired very early in the scheduling/planning/check-in process to start collections, and fits with the provider workflow for appointment scheduling and pre-visit eligibility verification. During this revised process, the personal health record (PHR), formulary, potentially credit checks, etc. can be pushed down to the provider to improve quality, care, and the provider's ability to collect payment for the services rendered.

In one embodiment, a unique process for calculating the patient liability, prior to services rendered, is enabled by collecting a minimal amount of provider/member data, along with the planned procedure codes and diagnosis. This data is used to create a “mock” claim in a HIPAA-compliant format. This claim gets processed by a claim processing engine (e.g., FACETS®) as a real-time claim, and is able to return the line item explanation codes that would result from an actual processed claim (EOB—even using HIPAA 835). While the “mock” claim is not posted (i.e., not committed), it is processed to determine the detailed results as with an actual claim, and the detailed results can be returned as an accurate estimation of the patient's liability. Further, this enables any errors that might be present in the claim data, etc. (which would occur in actual adjudication/posting of the claim) to be detected early so that they can be corrected.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which;

FIG. 1 shows an exemplary system according to one embodiment of the present invention;

FIG. 2 shows another exemplary system according to an embodiment of the present invention;

FIG. 3 shows another exemplary system according to an embodiment of the present invention;

FIG. 4 shows an exemplary claim adjudication system according to one embodiment of the present invention;

FIG. 5 shows an exemplary operational flow diagram according to an embodiment of the present invention;

FIG. 6 shows an exemplary graphical user interface for submitting claims to a claim adjudication system according to one embodiment of the present invention;

FIG. 7 shows an exemplary user interface presenting estimated healthcare payment information returned by the claim adjudication system in response to a submitted mock claim according to one embodiment of the present invention;

FIG. 8 shows an exemplary claim processing system according to one embodiment of the present invention;

FIG. 9 shows an exemplary operational flow for processing of information for an office visit to a physician according to one embodiment of the present invention;

FIG. 10 shows an exemplary operational flow for processing of information for a hospital visit according to one embodiment of the present invention;

FIGS. 11A-11D show exemplary user interfaces for defining an itinerary according to one embodiment of the present invention;

FIG. 12A shows an exemplary system according to one embodiment of the present invention;

FIG. 12B shows another exemplary system according to certain embodiments of the present invention;

FIG. 13 shows a more detailed implementation of a system employing an ETM in accordance with one embodiment of the present invention;

FIG. 14 shows an exemplary block diagram of one embodiment, which supports access via multiple provider channels;

FIG. 15 shows an exemplary block diagram of one embodiment, which enables a payer to create an itinerary of business rules configured to process a claim for a specific provider over a specific input channel;

FIG. 16 shows an exemplary block diagram of one embodiment, which allows service provider(s) to connect to multiple payers via a single solution; and

FIG. 17 shows an exemplary computer system on which various elements of embodiments of the present invention may be implemented.

### DETAILED DESCRIPTION OF THE INVENTION

Embodiments of the present invention provide enhanced systems and methods for processing of healthcare information. Various embodiments enable a request for estimated healthcare payment information to be submitted (e.g., as a mock claim) to a claim processing system, wherein information pertaining to the claim (e.g., payment information, such as the consumer's liability. EOB, etc.) can be returned from the claim processing system without the mock claim being committed/posted against the consumer's insurer. Certain embodiments enable real-time processing of information, such as claim data, to enable various improvements to pre-service and/or post-service processing of information. Thus, certain embodiments offer various improvements along the end-to-end flow of providing healthcare service to consumers. For instance, various improvements to the pre-service processing of information are provided by certain embodiments. That is, embodiments of the present invention enable improved processing of information before (or at the point of) healthcare service being rendered to a consumer. As described further herein, in certain embodiments various improvements are provided to a healthcare consumer before the healthcare consumer receives healthcare service from a service provider. Further, in certain embodiments, various improvements are provided to a healthcare service provider before the service provider renders healthcare service to a consumer.

Further, various improvements to the post-service processing of information are provided by certain embodiments. That is, embodiments of the present invention enable improved processing of information after healthcare service is rendered to a consumer. As described further herein, in certain embodiments various improvements are provided to a healthcare consumer after the healthcare consumer receives healthcare service from a service provider. Further, in certain embodiments, various improvements are provided to a healthcare service provider after the service provider renders healthcare service to a consumer, such as real-time processing of a claim for the service to enable reconciliation of the patient's liability before the patient leaves the service provider's office.

Thus, as described further herein, embodiments are provided that enable enhanced pre-service and/or post-service processing of healthcare information for healthcare consumers and/or service providers. Exemplary enhancements that are provided by certain embodiments at each of the various stages of the flow of healthcare provision are described further below.

Certain embodiments of the present invention provide systems and methods for pre-service processing of healthcare information. That is, systems and methods are provided that enable information pertaining to a specific healthcare service (e.g., a specific medical procedure, treatment, etc.) that is to be rendered to a member of a healthcare plan to be obtained and presented to the member, service provider, and/or other parties at or before the point of service (“POS”). For example, certain embodiments of the present invention enable pre-service processing of an expected claim for a desired healthcare service to enable a service provider (e.g., doctor), healthcare plan member (e.g., patient), and/or other parties to obtain information about the expected claim, such as an estimation of the member's liability for the service under the member's healthcare plan.

For instance, suppose a healthcare plan member desires to obtain certain healthcare services from a service provider, such as medical treatment for an illness, a physical examination, etc. Prior to receiving such service, the member and/or the service provider may submit a “mock” claim for the desired service to a processing system, whereby the processing system evaluates the submitted claim and returns information about the service under the member's healthcare plan, such as an estimation of the member's liability for the service under the member's healthcare plan. Various information pertaining to the specific service may be provided under embodiments of the present invention, including without limitation an estimate of the member's liability for the service, an indication of the service provider's eligibility under the member's healthcare plan, a summary of the member's benefits under the healthcare plan (e.g., an identification of healthcare services or procedures covered by the member's benefit plan, an identification of formularies (drugs) covered by the member's benefit plan, etc.), and the member's personal healthcare record(s). In certain embodiments, the service-specific information may also include financial information for the member, such as the member's credit score, identification of the member's healthcare financial accounts that are available (e.g., HSA, FSA, IRA, ESA, etc.), and their respective available balances, etc. Further, in certain embodiments, the information returned may include quality ratings and/or other information about the service provider under evaluation, and/or an identification of alternative service providers that may be used under the member's healthcare plan with their corresponding quality ratings and/or estimated patient liability, etc. Additionally, the information returned may, in certain embodiments, include identification of other alternative or complimentary healthcare services that may be considered instead of or in addition to the specific service under evaluation, along with the corresponding estimated liability and other information for such alternative or complimentary healthcare service.

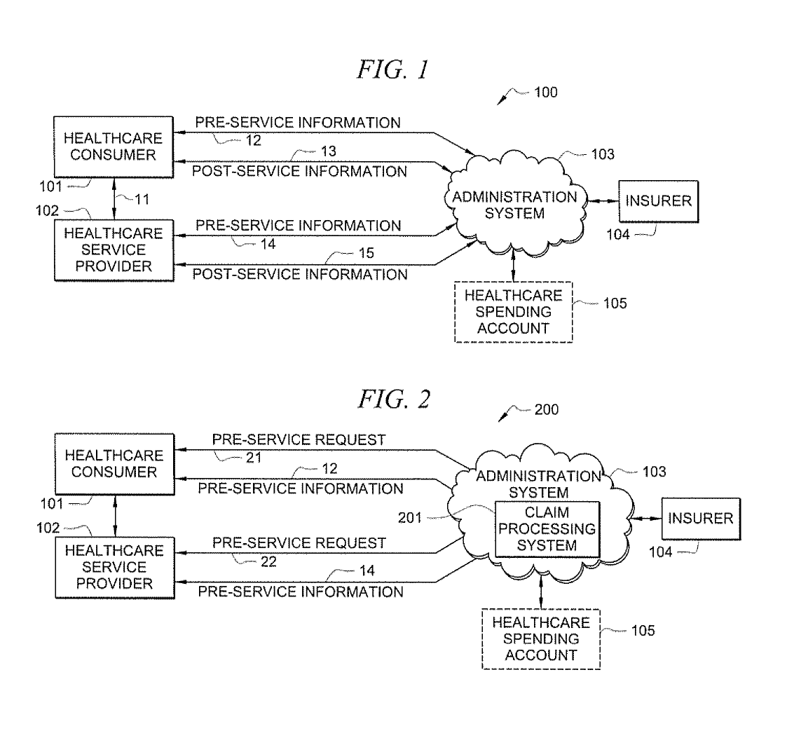

Turning to FIG. 1 an exemplary system 100 according to one embodiment of the present invention is shown. As shown, a healthcare consumer 101 has insurance coverage from an insurer 104. That is, the healthcare consumer 101 is a member of a healthcare plan from insurer 104. Healthcare consumer 101 may also have an established healthcare spending account 105 (e.g., MSA, HSA, FSA, HRA). According to this exemplary embodiment, healthcare consumer 101 desires to obtain service from healthcare service provider 102. Accordingly, certain interactions 11 may occur between the healthcare consumer 101 and the healthcare service provider 102, such as scheduling an appointment for service, receiving the desired service from the service provider, etc.

In this example, healthcare consumer 101 may interact with an administration system 103 to receive certain pre-service information 12 and/or certain post-service information 13. Pre-service information 12 may include any information pertaining to a specific healthcare service, such as an estimation of liability of the consumer under the consumer's healthcare plan, eligibility of a specific service provider to provide the healthcare service, explanation of benefits (EOB), and/or various other information described further herein. Similarly, the post-service information 13 may include any information pertaining to a specific healthcare service, such as information commonly returned for a processed/adjudicated claim (e.g., EOB), and/or various other information described further herein.

Similarly, healthcare service provider 102 may interact with administration system 103 to receive certain pre-service information 14 and/or certain post-service information 15. Pre-service information 14 may include any information pertaining to a specific healthcare service, such as an estimation of liability of the consumer under the consumer's healthcare plan, eligibility of a specific service provider to provide the healthcare service, explanation of benefits (EOB), and/or various other information described further herein. Similarly, the post-service information 15 may include any information pertaining to a specific healthcare service, such as information commonly returned for a processed/adjudicated claim (e.g., EOB), and/or various other information described further herein.

In general, an “administration system” refers to any system operable to administer a request for information for a specified service and determine information related specifically to the specified service such as an indication of a service provider's eligibility under the healthcare consumer's healthcare plan, an estimate of the healthcare consumer's liability for the service tinder the consumer's healthcare plan, etc. As described further herein, healthcare consumer 101 may request and receive the pre-service information 12 from administration system 103 via a communication network, such as the Internet. For instance, the healthcare consumer 101 may use a personal computer (PC), laptop computer, or other processor-based device to communicatively couple via a network to the administration system 103. In certain embodiments, the administration system 103 may be accessed by the healthcare consumer 101 via a website.

In this example, prior to the desired service being rendered, the administration system 103 may receive information from the healthcare consumer 101 regarding the desired healthcare service, the healthcare service provider 102 whom the healthcare consumer 101 desires to perform the service, etc. The administration system 103 then determines various information pertaining to the desired service. For instance, the administration system 103 may evaluate the consumer's healthcare plan and determine whether the healthcare service provider 102 is an eligible service provider under the plan. The administration system 103 may also evaluate the consumer's healthcare plan to determine whether and to what extent the desired service is covered by the healthcare plan. The administration system 103 may also evaluate the consumer's healthcare plan and determine an estimate of the consumer's liability for the desired service under such plan. Such an estimate of the consumer's liability may include an indication of the consumer's co-payment amount, co-insurance amount, outstanding deductible amount, as well as other terms of the healthcare plan that pertain to the desired service. Further, the administration system 103 may evaluate healthcare spending account(s) 105 of the consumer and provide the consumer with information regarding those accounts and their respective balances (so that the consumer can be informed as to whether sufficient balance is present in the account(s) 105 to satisfy the consumer's estimated liability). Thus, the healthcare consumer 101 may, in certain embodiments, receive useful and accurate information pertaining specifically to the desired service before actually receiving such service. Accordingly, the consumer 101 is made aware before obtaining the service to what extent the consumer's healthcare plan covers the desired service, the consumer's estimated liability, etc.

Similarly, in this example, the administration system 103 may receive information from the service provider 102 regarding the desired healthcare service, the consumer 101 to whom the service is to be provided, etc. For instance, upon consumer 101 scheduling an appointment with the service provider 102 for the desired service, the service provider 102 may (e.g., before actually rendering the service to the consumer 101) request pre-service information 14 from the administration system 103. The administration system 103 then determines various information pertaining to the desired service. For instance, the administration system 103 may evaluate the consumer's healthcare plan and determine whether the healthcare service provider 102 is an eligible service provider under the plan. The administration system 103 may also evaluate the consumer's healthcare plan to determine whether and to what extent the desired service is covered by the healthcare plan. The administration system 103 may also evaluate the consumer's healthcare plan and determine an estimate of the consumer's liability for the desired service under such plan. Such an estimate of the consumer's liability may include an indication of the consumer's co-payment amount, co-payment insurance amount, outstanding deductible amount, as well as other terms of the healthcare plan that pertain to the desired service. Further, the administration system 103 may evaluate healthcare spending account(s) 105 of the consumer and provide the service provider with information regarding those accounts and their respective balances. Further, in certain embodiments, the consumer's healthcare records may be provided to the service provider 102 as part of the pre-service information 14. Thus, the service provider 102 may, in certain embodiments, receive useful and accurate information pertaining specifically to the desired service for consumer 101 before actually rendering such service. Accordingly, the service provider 102 may use such information to inform the consumer 101, before rendering the service, to what extent the consumer's healthcare plan covers the desired service, the consumer's estimated liability for the service, etc.

In certain embodiments, service provider 102 submits a mock claim for the desired service to the administration system 103 in order to request the pre-service information 14. In such embodiments, the administration system 103 may evaluate the mock claim to ensure that it is in the proper form for processing (e.g. as for an actual claim), and the administration system 103 may inform the service provider of any errors in the mock claim. In this manner, the service provider 103 can determine the appropriate format of the claim (e.g., the appropriate procedure codes, etc.) prior to rendering the service and actually submitting a claim for the service. In certain embodiments, the mock claim may be saved (e.g., to the healthcare service provider 102's computer and/or to the administration system 103) and simply re-submitted as an actual claim after the service is rendered. In certain embodiments, a “submit” button or other user interface may be provided to enable the service provider 102 to easily re-submit a mock claim as an actual claim to the claim processing system for actual processing of the claim, rather than for obtaining the pre-service information, such as estimated consumer liability, etc.

In certain embodiments, post-service information 13 may be obtained by healthcare consumer 101 from administration system 103, and/or post-service information 15 may be obtained by healthcare service provider 102 from administration system 103. For instance, in certain embodiments, a mock claim that is processed pre-service can be used for re-submission as an actual claim post-service, which is processed by a claim processing system (e.g., claim adjudication system) to return information identifying the consumer's actual liability for the service (e.g., as part of post-service information 15). Thus, a pre-processed mock claim can be re-submitted as an actual claim, which may ease the post-service claim submission process.

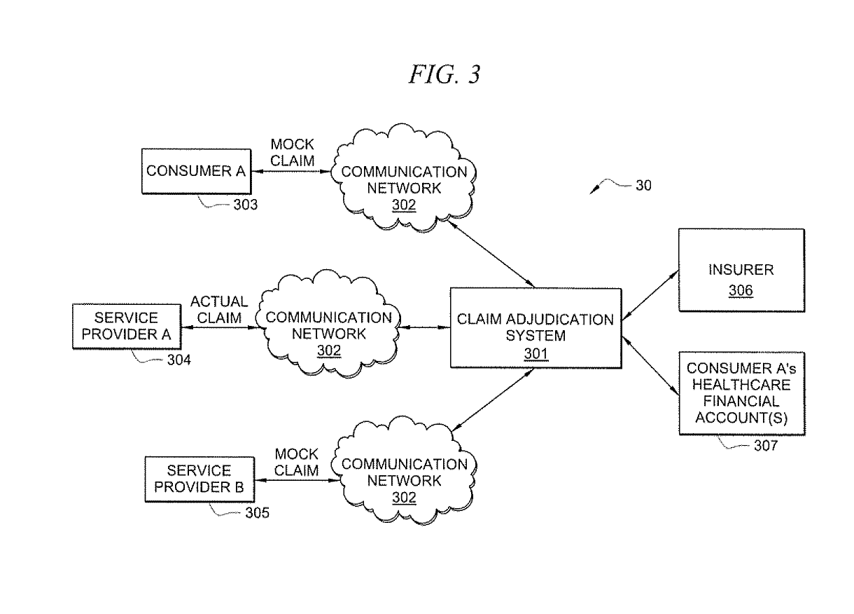

FIG. 2 shows another exemplary system 200 according to an embodiment of the present invention, wherein administration system 103 comprises a claim processing system 201. Such a claim processing system 201 is operable to process a submitted claim and determine (e.g., using adjudication logic) an insurer's liability and/or a consumer's liability for rendered service. Various claim processing systems are known, such as the product commercially known as FACETS® available from The Trizetto Group, Inc. In this exemplary system, the claim processing system 201 is used to not only adjudicate actual claims, but is also used to process mock claims in order to determine an estimate of the insurer's and/or consumer's liability for a desired service.

For instance, healthcare consumer 101 may input a pre-service request 21 requesting pre-service information 12 about a desired service. The pre-service request 21 may include information that is input (e.g., via a user interface on a website) to administration system 103, which administration system 103 uses to generate a mock claim that is input to claim processing system 201 to determine the insurer's and/or consumer's liability if the mock claim were submitted as an actual claim. The mock claim may include a associated information (e.g., a “tag”) that identifies it as a mock claim, rather than an actual claim, so that the claim processing system understands that it is not an actual claim to be adjudicated and committed/posted. Once the administration system 103 determines the consumer's liability for the mock claim from the claim processing system 201 (and/or other information pertaining to the desired service, as mentioned above), such information is returned to the consumer 101 as part of pre-service information 12.

Similarly, service provider 102 may input a pre-service request 22 requesting pre-service information 14 about a service desired by healthcare consumer 101. The pre-service request 22 may include information that is input (e.g., via a user interface on a website) to administration system 103. In certain embodiments, the service provider 102 submits a mock claim to the administration system 103. The mock claim includes information similar to an actual claim for the desired service, such as corresponding procedure code, member identification, service provider identification, etc., as well as associated information (e.g., a tag) that identifies the claim as a mock claim, rather than an actual claim. Thus, the mock claim is input to the claim processing system 201, and the claim processing system 201 understands (e.g., based on the tag) that the mock claim is not an actual claim to be adjudicated and committed/posted. Once the administration system 103 determines the consumer's liability for the mock claim from the claim processing system 201 (and/or other information pertaining to the desired service, as mentioned above), such information is returned to the service provider 102 as part of pre-service information 14.

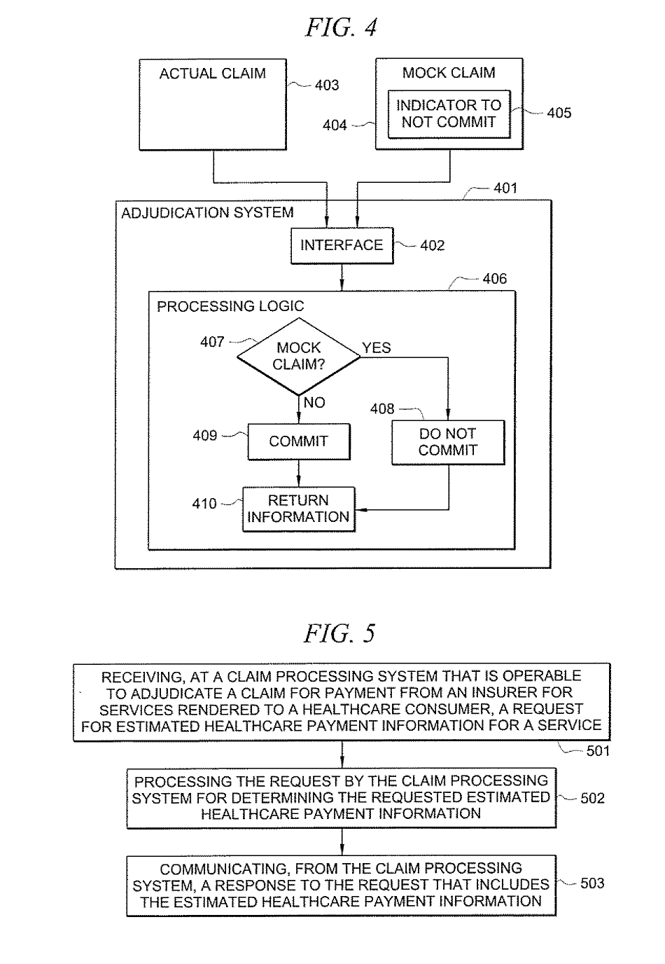

FIG. 3 shows an system 30 according to one embodiment of the present invention. System 30 comprises a claim adjudication system 301 (e.g., which may be implemented within claim processing system 201 of FIG. 2) that is communicatively coupled, via communication networks 302, to one or more entities, such as consumer A 303, service provider A 304, and service provider B, 305. Additionally, claim adjudication system 301 may be communicatively coupled, e.g., via a communication network 302, to an insurer system 306 and/or a consunmer's healthcare financial account 307, such as an MSA, HSA, FSA, HRA, and/or other funds available to the consumer for use for payment for healthcare services. Communication networks 302 may, as examples, comprise the Internet or other wide area network (WAN), a local area network, public-switched telephony network, wireless network, any combination of the foregoing, and/or any other communication network now known or later developed that permits two or more computers to communicate with each other.

In the illustrated example, consumer 303 may interact with a user interface, such as a web interface, to submit to the claim adjudication system 301 a mock claim for healthcare services that are being considered by the consumer, wherein the claim adjudication system 301 returns estimated healthcare payment information, such as the consumer's liability, EOB, etc., for the services indicated in the mock claim. Similarly, in this example, service provider 305 submits a mock claim for healthcare services that are being considered for a given consumer, wherein the claim adjudication system 301 returns estimated healthcare payment information, such as the given consumer's liability, EOB, etc., for the services indicated in the mock claim. Claim adjudication system 301 is also operable to adjudicate actual claims, and thus in the illustrated example, service provider 304 submits an actual claim for healthcare services that have been rendered to a given consumer, wherein the claim adjudication system 301 commits/posts the claim (e.g., to the consumer's insurer 306 and returns estimated healthcare payment information, such as the given consumer's liability, EOB, etc., for the services indicated in the actual claim. In certain embodiments, the submitted actual claim may have previously been submitted as a mock claim, and the mock claim may be re-called on the service provider's system 304 and re-submitted as an actual claim.

In certain embodiments, in response to a mock (or actual) claim, funds may be determined by claim adjudication system 301 as available in one of the consumer's healthcare accounts 307. For instance, in response to a mock (or actual) claim being submitted, the claim adjudication system 301 may determine the consumer's liability for the claim, and may also interact with the consumer's healthcare financial accounts 307 to determine an amount of funds available in such accounts that may be used for payment for such liability. The determined information, including the consumer's liability and the determined amounts available in the healthcare financial accounts 307, may be returned from the claim adjudication system 301 to the requesting party (e.g., to consumer 30) and/or service provider 304-305 in the illustrated example). In certain embodiments, in response to a mock claim returning an estimated liability and determination of funds being available in financial accounts 307, consumer 303 and/or service provider 304 may request a “hold” on some amount of the finds in financial accounts 307 (e.g., an amount corresponding to the estimated consumer's liability), wherein such funds may be held for a period of time (e.g., until a later actual claim is submitted, a later release is submitted as payment is otherwise received for services rendered or a decision was made to forego the services identified in the mock claim, or a period of time, such as 60 days, expires without a request for the funds being held to be paid to a service provider).

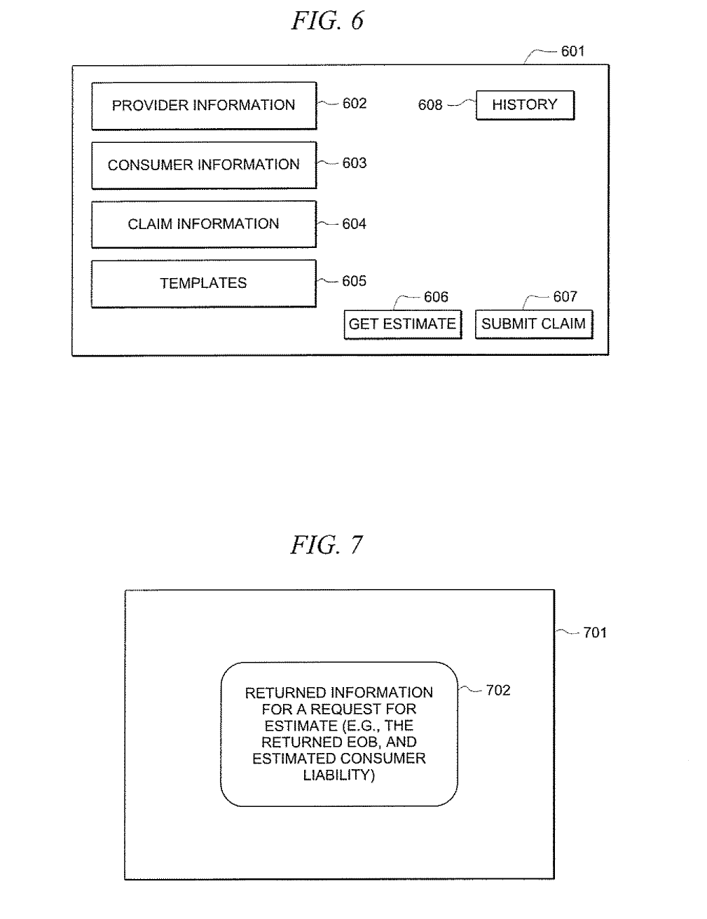

Turning now to FIG. 4, an exemplary claim adjudication system 401 (e.g., the claim adjudication 301 shown in the exemplary embodiment of FIG. 3) that is implemented according to certain embodiments of the present invention is shown. As shown, claim adjudication system 401 includes an interface 402 that is operable to receive electronic communication of data that comprises an actual claim for healthcare services, such as actual claim 403, and adjudicate such actual claim to determine a consumer's liability, the consumer's insurer's liability, etc., and return such healthcare payment information as an EOB. Exemplary claim adjudication systems that are operable for so processing electronically submitted claims are well-known in the art, and include as an example the software product commercially known as FACETS® available from The Trizetto Group™, Additionally, interface 402 of claim adjudication system 401 is operable to receive electronic communication of data that comprises a mock claim for healthcare services, such as mock claim 404, and adjudicate such mock claim to determine a consumer's liability, the consumer's insurer's liability, etc., and return such healthcare payment information as an EOB, without committing/posting the determined liability to the insurer (as with an actual claim). In certain embodiments, mock claim 404 has information associated therewith, such as an indicator 405, from which claim adjudication system 401 is capable of recognizing the claim as a “mock” claim and thus not commit the determined liability amounts.

Accordingly, claim adjudication system 401 further comprises processing logic 406 for processing received actual and mock claims for determining the corresponding healthcare payment information (e.g., consumer liability, EOB, etc.) for the healthcare services included in such received claims. As discussed hereafter, in addition to adjudicating the received actual claim 403 or mock claim 404 for determining healthcare payment information, such as consumer liability, insurer liability, etc., adjudication system 401 includes processing logic 406 that is operable to determine whether to commit such adjudicated claim for payment of the determined liability. In this example, the processing logic 406 is operable to determine, in operational block 407, whether a received claim is a mock claim. Such determination may be made based on whether associated information, such as indicator 405, for a received claim indicates the claim is a mock claim. If determined that a received claim is a mock claim, the claim is processed/adjudicated just as an actual claim, except in operational block 408, the determined liability is not committed for the claim. Thus, the liability amounts of the consumer and the insurer, etc. are not actually committed to the consumer's insurer for payment. Otherwise, if the claim is determined to be an actual claim, then the liability amounts are committed as traditionally done for submitted claims, in operational block 409. In either case, the determined healthcare payment information (e.g., consumer's liability, EOB, etc.) for the claim is returned to the party who submitted the claim in operational block 410.

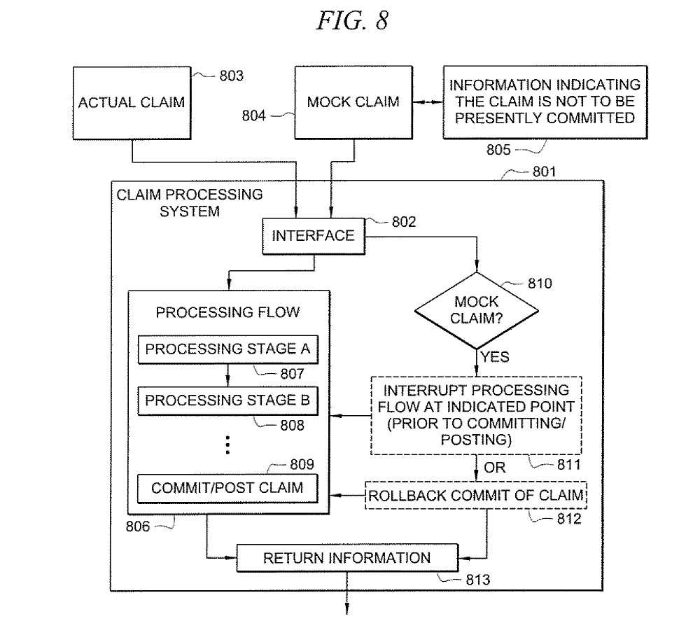

FIG. 5 shows an exemplary operational flow according to one embodiment of the present invention, In operational block 501, a claim processing system receives a request for estimated healthcare payment information for a service, which may be a service that has not yet been rendered to the healthcare consumer. The claim processing system is operable to adjudicate a claim for payment from an insurer to a service provider for services rendered to a healthcare consumer. In certain embodiments, as described further herein, the request for estimated healthcare payment information is submitted to the claim processing system as a mock claim that has information associated therewith indicating that such mock claim is not to be committed as an actual claim. In block 502, the claim processing system processes the request (e.g., the mock claim) for determining the requested estimated healthcare payment information. In block 503, the claim processing system communicates a response to the request that includes the estimated healthcare payment information, such the consumer's liability, EOB, etc.

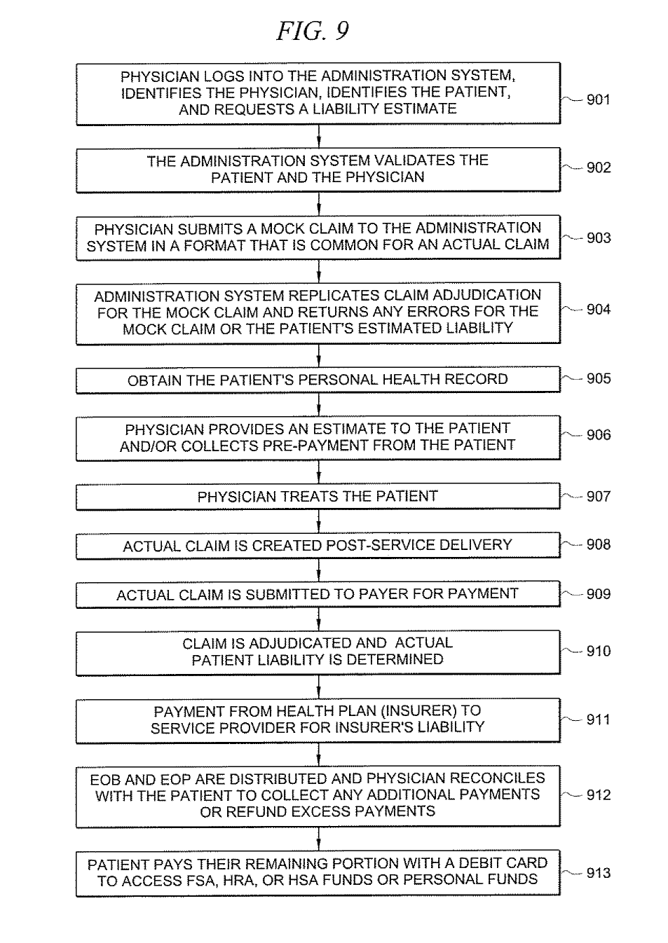

According to certain embodiments, a common user interface may be used for inputting information for forming either an actual or a mock claim that is to be submitted for processing by a claim adjudication system. For instance, a healthcare provider may interact with such a common user interface to prepare and submit either an actual or a mock claim. FIG. 6 shows an example of such a common user interface 601 according to one embodiment of the present invention. User interface 601 is a graphical user interface that is presented on a computer system by software code that is executing either locally on such computer system (e.g., locally on the healthcare provider's system) or remotely therefrom (e.g., executing on a web server and accessible to the healthcare provider via the Internet). Exemplary interface 601 includes portion 602 for receiving input of information pertaining to the service provider, e.g., identifying the service provider, etc. Exemplary interface 601 also includes portion 603 for receiving input of information pertaining to a given healthcare consumer, e.g., identifying the consumer, etc. Exemplary interface 601 also includes portion 604 for receiving input of information pertaining to a given claim (either an actual claim or a mock claim), e.g., identifying the claim codes for one or more healthcare services to be included in the claim. It should be recognized that in this example, the portion 604 of the interface 601 for receiving information pertaining to a claim is the same for either an actual claim or a mock claim.

According to us exemplary embodiment, interface 601 supports templates 605. That is, a healthcare service provider may create certain templates that when recalled will automatically populate the various fields of claim information 604. For instance, a healthcare provider who performs many knee replacement surgeries may create a “knee replacement” template 605, which when selected on interface 601 automatically populates the various fields (e.g., claim codes, etc.) of claim information 604 for such a procedure. Such templates may be created for any number of healthcare services. Further, once a template is recalled to automatically populate the fields of claim information 604, the healthcare provider may modify any of such fields of claim information 604 as may be desired for a given consumer, prior to submitting the claim.

Once the claim information 604 is completed either manually or through selection of a pre-defined template, either of submission buttons 606 or 607 may be selected (e.g., clicked with a mouse or other input device) to trigger communication of a request pertaining to such claim to a claim adjudication system, such as the exemplary claim adjudication system 401 of FIG. 4. If the “Get Estimate” button 606 is selected, then the claim information is submitted as a mock claim (e.g., mock claim 404 of FIG. 4) to the claim adjudication system, whereas if the “Submit Claim” button 607 is selected, the claim information is submitted as an actual claim (e.g., actual claim 403) to the claim adjudication system. Thus, for instance, when the Get Estimate button 404 is selected, an indicator, such as indicator 405 in FIG. 4, may be associated with the claim that indicates to the claim adjudication system that such claim is a mock claim.

As further show, once a mock claim is submitted (e.g., by selecting Submit Claim button 607), it may be saved as a mock claim for the given healthcare consumer to the computer system, wherein previously submitted claims may be recalled (e.g., to be re-presented on user interface 601) by selecting “History” button 608. Once a previously submitted mock claim is recalled, it may be modified, if so desired, or left as is (if it accurately reflects the healthcare services rendered to a consumer), and then such recalled mock claim may be submitted as an actual claim by then selecting Submit Claim button 607.

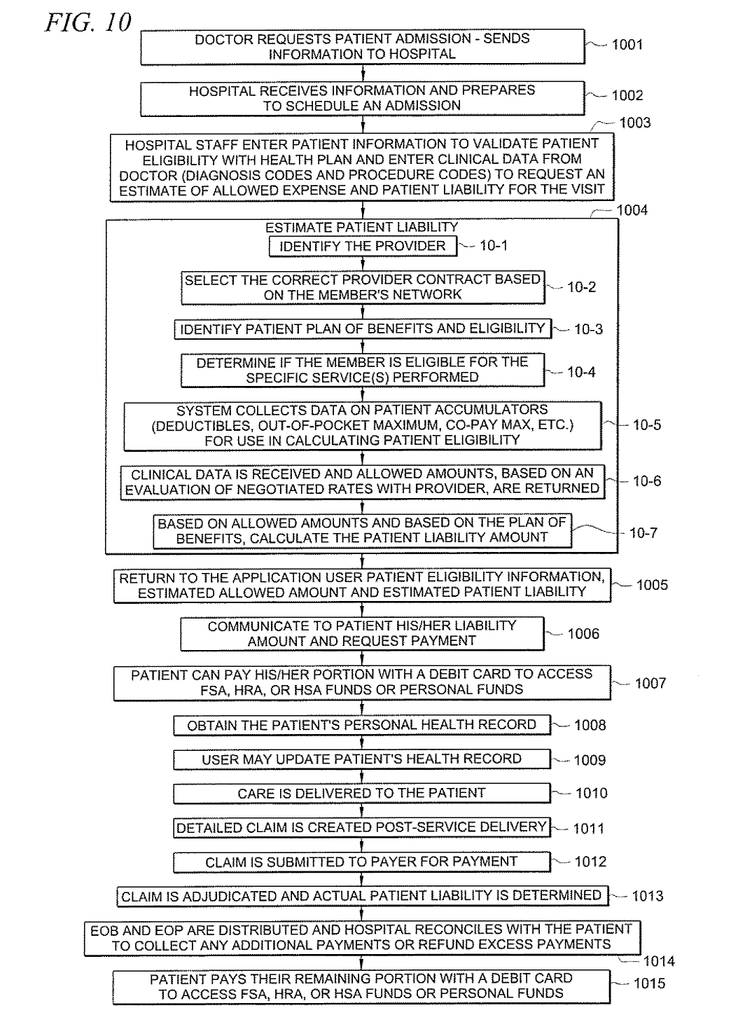

According to certain embodiments of the present invention, in response to a mock claim being submitted (e.g., in response to submission of claim information 604 via Get Estimate button 606 in FIG. 6), various estimated healthcare payment information is returned, such as an indication of the consumer's liability, an EOB, and/or other information that is similar to the healthcare payment information that is returned in response to submission of an actual claim (e.g., via Submit Claim button 607). FIG. 7 shows an example of a user interface 701 that shows illustrative estimated healthcare payment information 702 that may be returned from a claim adjudication system in response to a submitted mock claim (e.g., in response to the Get Estimate button 606). Various other features may be included in a user interface according to certain embodiments. For instance, a “save” feature may be included that allows the recall of liability to change, edit, and even submit. As another example, an inquiry feature allows return of all submitted claims and liability requests, and allows for claims that were submitted that did not pend, ability to correct them in real time against the real system and adjudicate.

While the exemplary user interfaces of FIGS. 6 and 7 are described above as being presented on a service provider's system, certain embodiments present healthcare consumers a web interface that enables the healthcare consumers to generate the submission of mock claims. Generally, healthcare consumers are not aware of claim codes. etc. for various healthcare services. However, such a web interface may enable a healthcare consumer to designate a desired healthcare service(s) that is of interest, and the web interface may prepare and submit a corresponding mock claim to a claim adjudication system for such desired healthcare service(s). For instance, generic templates containing typical claim codes, etc., for corresponding healthcare services may be available for use in submitting a mock claim in response to a selected service. For instance, a generic template may be available for a knee replacement procedure, and a consumer may select via the web interface to receive an estimate for a knee replacement procedure, wherein the generic template for that procedure may be used for preparing and submitting a mock claim to the claim adjudication system. In certain embodiments, healthcare provider-specific templates, such as templates 605 described above with FIG. 6, may be used for generating a mock claim for a consumer when the consumer specifies not only a procedure, but also the healthcare provider to be used for such procedure.

Additionally, in certain embodiments, comparative healthcare payment information (and/or other information, such as quality ratings of various service providers, etc.) may be returned to the healthcare consumer. For instance, estimates may be returned for a plurality of different providers (e.g., in the consumer's geographic area) for a given healthcare service that is selected as of interest to the consumer, wherein such estimates may be determined using corresponding templates of the respective providers or on another basis.

Additionally, according to certain embodiments, certain complimentary services and corresponding estimates (and some indication of likelihood of such complimentary services being required) may also be returned. For instance, in response to a mock claim being submitted (e.g., either by a healthcare provider or by the consumer) for a knee replacement procedure, various complimentary services that may be required (e.g., in the event of complications with the procedure) may be identified and corresponding healthcare payment estimates returned. For example, an indication that in 85% of knee replacements X amount of physical therapy is required, with a corresponding estimate for such physical therapy may be returned; an indication that in 78% of knee replacements X amount of pain medication is required during recovery from the procedure, with a corresponding estimate for such pain medication may be returned; and an indication that in 18% of knee replacements post-operative infection is encountered, with a corresponding estimate for treatment for such infection, etc. In this manner, the consumer (and/or healthcare provider) may be made aware of various complimentary expenses that may be encountered for a given healthcare service.

Further, according to certain embodiments, the claims (e.g., mock or actual) may be for an entire “episode of care” and may thus include a number of healthcare services that are included as part of such episode of care. As an example, the number of nights stayed in the hospital, examinations, medications, surgical procedures, etc. associated with a given episode of care, such as associated with a knee replacement, may be included in a given mock or actual claim.

And, according to certain embodiments, alternative healthcare services to a given healthcare service may be determined (e.g., determined by the claim adjudication system or other system, by the service provider, and/or by the consumer) and estimated healthcare payment information for such alternative services may be returned. For instance, as an alternative to knee replacement surgery that is submitted in a mock claim, a certain amount of physical therapy and/or other potentially viable alternative procedures may be determined and corresponding estimated healthcare payment information may be returned for those alternative procedures in addition to the estimated payment information for the knee replacement procedure. In this manner, the consumer may be well-informed and better equipped for managing the financial responsibility for his/her healthcare treatment.

An exemplary operational flow according to one embodiment of the present invention is now described for illustrative purposes. According to such exemplary operational flow, a member (or “healthcare consumer”) desiring medical service logs onto an administration system and requests pre-service information for the desired service. For instance, the administration system may be accessible via a website, wherein the member inputs information identifying the member, the desired service, the service provider to render the service, etc. The member receives from the administration system information pertaining to the desired service, such as an indication of eligibility of the selected service provider, estimated liability of the member, etc. The member may then evaluate the pre-service information determine whether to proceed with the service, in which case the member schedules an appointment with the service provider for the desired service.

Responsive to the member scheduling the desired service, the service provider may log onto the administration system and request pre-service information pertaining to the desired service. Such a request may comprise submission of a mock claim for the desired service, for example. The service provider receives pre-service information pertaining to the desired service, such as an indication of the member's summary of benefits under the member's healthcare plan, an indication of eligibility of the service provider under the member's healthcare plan, estimated liability of the member, etc. Various other information pertaining to the specific service may be included in the pre-service information, including the member's healthcare records, an indication of the member's financial status (e.g., credit score, available healthcare spending accounts with corresponding balances, etc.).

The service provider may determine, based at least in part on the estimated member's liability and the member's financial status) whether to require some form of pre-service payment from the member, which the service provider may collect from the member prior to rendering the service. The member receives the desired service from the service provider. The service provider submits an actual claim to the administration system for the service rendered. In certain embodiments, the mock claim used for requesting the pre-service information may be saved and re-submitted as an actual claim.

In certain embodiments, as described further herein, the claim processing (of a mock claim and/or an actual claim) may be performed in real-time, as opposed to traditional batch processing. Thus, according to this exemplary operational flow, the claim may be processed and the member's liability amount returned to the service provider in real-time. Thereafter the service provider collects any outstanding balance on the member's liability (e.g. above any pre-service amount paid) from the member. In certain embodiments, because the claim is processed in real-time, the service provider may bill the member and the member may pay for the member's liability before leaving the service provider's office. In this manner, the provision of the healthcare service becomes analogous to traditional consumer transactions in which a consumer pays for the service at the point of service (e.g., pay for grocery items when checking out at a grocery store, etc.).

The above-described operational flow is beneficial to both the member and the service provider. The member and service provider can each receive pre-service information pertaining to the desired service to verify the service provider's eligibility, the member's estimated liability, etc. under the member's healthcare plan. This minimizes the surprises that may arise after the service is actually rendered regarding the amount of liability of the member, etc. Further, the service provider can use the estimated liability to determine an appropriate amount (if any) that should be collected from the member prior to rendering the service. Also, the real-time processing capability affords the service provider an opportunity to bill and collect for a service at the point of such service (e.g., before the member leaves the service provider's office). This allows for the service provider to alleviate delays, problems, and expenses associated with billing and collecting for a service after the point of service (e.g., after the member receives the service and leaves the service provider's office).

An exemplary operational flow for actions supported for a healthcare consumer prior to receiving healthcare service from a service provider according to one embodiment of the present invention is now described for illustrative purposes. Various stages exist at which a healthcare consumer may perform some action prior to receiving healthcare service, including benefit plan selection and enrollment, enroll/establish financial accounts, setup/manage financial accounts, manage personal health records, evaluate healthcare treatment options, and select provider/schedule appointment, as examples.

At the benefit plan selection and enrollment stage, the consumer may interact with an administration system (e.g., via a website or other user interface) to perform various actions for selecting and enrolling in a benefit plan. For instance, the consumer may review various plans, benefit options and incentives. The system may estimate total cost of care under each of the various plans, including a forecast of out of pocket expenses, utilization, cost of care and drugs, etc. Such an estimation may be provided, for example, using a history of prior claims submitted for the consumer and/or using the consumer's personal health record. The consumer may select and customize the benefit plan by selecting various options, such as pharmacy, vision, maternity, provider network, care and disease management programs, deductible levels, co-payment amounts, co-insurance, retail discount programs, etc. The consumer may receive a quote based on the benefit selections, and the consumer may compare prices for benefit selections across multiple benefit plans. The consumer may then make an informed choice to select and enroll in a plan that the consumer believes to be the best fit for the consumer. In certain embodiments, HSA and FSA tax savings and long term financial healthcare planning tools may be available through the administration system. In certain embodiments, the administration system may recommend HSA and FSA contributions. In certain embodiments, the administration system integrates with Health Risk Assessment, prior experience and predictive modeling to improve estimates.

At the enroll/establish financial accounts stage, a consumer may interact with an administration system (e.g., via a website or other user interface) to perform various actions for enrolling and establishing financial accounts (e.g., healthcare spending accounts). The consumer may evaluate payment methods and financial accounts for payment of healthcare services, procedures, and purchase of products, drugs, DME, etc. The consumer may compare the accounts based on benefits, utilization, etc. The payment methods may include: a) Healthcare spending accounts (MSA, HSA, FSA, HRA, Others), b) Credit card, c) Debit Card, d) Bank Loan or Line of Credit, e) Payroll Deduction, and f) Investment Options, as examples. The consumer can evaluate payment methods for health insurance premium payments. The consumer can evaluate and compare payment methods/accounts to, for example, assess risks, tax benefits, and investment options. The consumer can select and enroll/apply for payment methods and/or financial accounts. The consumer can, based on financial analysis, intelligently select and enroll in a desired plan.

At the setup/manage financial accounts stage, a consumer may interact with an administration system (e.g., via a website or other user interface) to perform various actions for setting up and managing financial accounts. According to embodiments of the present invention, the consumer can setup/configure approved payment methods, and/or financial accounts, such as: a) Contribution levels and methods of funding, b) Loan/Credit amounts, terms and limits, c) Automated payments/withdrawals/deposits and terms, EFT and d) Authorizations for credit check, account access. The consumer may configure and receive a financial health statement. The consumer may develop and manage healthcare savings and investment plan. According to embodiments of the present invention, the consumer can check balances of healthcare financial accounts (in real-time). The consumer can check balance of deductibles, and review claims and payment history and status. According to embodiments of the present invention, the consumer can download financial data (which may be downloaded in any of multiple formats for desktop apps, such as Quicken®). In certain embodiments, a consumer may configure and receive a financial health statement, wherein care and analytics may be included in such statement. Thus, the statement may show how savings of care under a disease management program is integrated. According to certain embodiments, analytics may be included that show the member's actual claims history, medical costs, etc. under a disease management program, as well as how much the member saved over the year because of the health plan program in which they were enrolled (and/or how much they could have saved if enrolled in a different health plan program). An estimation of savings under one or more health plan programs for the upcoming year may also be included (e.g., based on the member's claim history and/or personal health record).

At the manage personal health records stage, a consumer may interact with an administration system (e.g., via a website or other user interface) to perform various actions for managing personal health records. The consumer can set up and maintain a personal health record (PHR). The consumer may establish a PHR with a selected health plan. According to embodiments of the present invention, the consumer can configure privacy and consent parameters for exchange of PHI and PHR. The consumer may provide PHR to the health plan, providers, and other constituents (family, new health plan, 3rd parties, etc). The PHR may be so provided using any of multiple secure methods (browser, automated upload through email, internet transfers, etc.). According to embodiments of the present invention, the consumer can securely exchange PHR using any of multiple formats, such as Adobe, HL7, etc. Any of multiple import/export methods, such as extract from desktop application or from external source or RHIO may be used to send the PHR to a desired destination.

At the evaluate healthcare treatment options stage, a consumer may interact with an administration system (e.g., via a website or other user interface) to perform various actions for evaluating healthcare treatment options. The consumer may assess need for healthcare services/products. According to embodiments of the present invention, the consumer may interact with the administration system to select a treatment or procedure that best fits the consumer's expected needs. The consumer can evaluate care options (e.g., what procedures and drugs and services are covered under the consumer's healthcare plan). The consumer can get an estimated cost of treatment or procedure (e.g., an average cost). The consumer can evaluate costs and quality of care across different providers and treatment options. According to embodiments of the present invention, the consumer can receive accurate patient liability for a provider with specific planned procedures (e.g., receive estimated liability for inpatient stays). And, the consumer can compare costs, quality of care, and benefits across multiple providers. In certain embodiments, the administration system may offer retail product purchases (e.g., at a discount based on the consumer's health plan). In certain embodiments, the system administrator enables the consumer to initiate dialog with a “treatment coach” and perform population management.

At the select provider/schedule appointment stage, a consumer may interact with an administration system (e.g., via a website or other user interface) to perform various actions for selecting a provider and scheduling an appointment with the provider. The consumer can select the provider/facility, contact the provider, and schedule an appointment. The provider may communicate patient liability amount to the consumer at this point (e.g., as discussed further herein, embodiments of the present invention may be employed to enable a service provider to obtain an accurate pre-service estimate of patient liability). The provider may, if desired, ask for pre-payment (partial or full), request how payment will be made, setup a payment plan, accept a credit card, etc. The member can thus receive an accurate estimate for specific procedures and specific provider based on previous automated inquiries. Facility/Inpatient estimates will vary due to average liability, and varying collection methods. The consumer can access PHR and send the PHR to the provider via email, or via a provider selected method from the payer, and in optional format such as Adobe or HL7. The consumer can receive formulary and latest PHR from his health plan based on scheduling an appointment with the provider (e.g. scheduling the appointment may trigger sending this information to the consumer and/or to the service provider). The consumer can also receive care management and pre-visit guidelines from the health plan prior to receiving the healthcare service.

An exemplary flow for actions supported for a healthcare service provider prior to rendering healthcare service to a consumer according to certain embodiments of the present invention is now briefly described for illustrative purposes. This exemplary flow identifies various stages at which a healthcare service provider may perform some action prior to rendering healthcare service, including health plan contracting and setup, planning for patient scheduling, scheduling and processing patients, and preparing patient's health records, as examples.

At health plan contracting and setup stage, a service provider may interact with an administration system (e.g., via a website or other user interface) to perform various actions for health plan contracting and setup. For instance, the service provider can contract with one or more health plans, wherein such contract defines payment methodologies, network discounts, benefit plans, programs and discounts (retail, care, etc.), and/or other provisions of the relationship. According to certain embodiments of the present invention, the service provider may setup health plan tools for point of service estimated liability and claims processing (for real-time and/or batch processing). The service provider may setup health plan tools for personal health record tools, upload, download, exchange between member, health plan, other providers, and/or other constituents. The health plan's tools (e.g., available through the administration system described further herein) may be implemented in conjunction with PMS, HIS, EMR, Web Browser/Portal, etc. In some instances, adapters may be employed for supporting the interaction for performing the new transactions described herein (e.g., such as the adapters described in co-pending and commonly assigned U.S. patent application Ser. No. 10/965,253 titled “INTERFACING DISPARATE SOFTWARE APPLICATIONS” filed Oct. 14, 2004, the disclosure of which is hereby incorporated herein by reference). In certain embodiments the tools may support claims, PHR, formularies, clinical guidelines, and other pre-care transactions received in multiple formats, multiple channels, real time or batch. Further, the service provider may setup alternative care options offered by the health plan, such as online nurse, bid for services, etc. The service provider may establish and setup health plan quality program, performance benchmarks and incentives. Also, the service provider may sign-up for healthcare retail offerings for provider and/or the provider's consumers who are members of the health plan.

At the planning for patient scheduling stage, a service provider may interact with an administration system (e.g., via a website or other user interface) to perform planning for patient scheduling. For instance, a hospital may receive physician referral and manage physician/hospital scheduling (via multiple methods—fax, call, paper, online, portal, within provider system). The service providers may receive request ‘for bid’ on care/services based on “network/group venture” (via multiple methods—fax, call, paper, online, portal, within provider system). Members may contact providers to discuss services needed, plan and schedule care (via multiple methods—call, online provider portal, health plan scheduling integration or portal, etc.). According to certain embodiments of the present invention, the service provider may conduct patient liability inquiry with the health plan on all referred and scheduled and walk-in patients (e.g., using the new transactions described herein which are enabled by the administration system). The request may include data such as provider and member information, plan identification, date of service, planned procedures or services, diagnosis, etc.

For the hospital environment, liability calculation may incorporate various reimbursement methodologies and specific provider contracts that impact reimbursement for the provider and specific service types, etc contracting to determine patient liability for hospitals. Liability calculation may be performed for inpatient and outpatient/ambulatory type procedures. Both the accurate patient liability and the estimated patient liability are available and configurable for the provider's needs.

For the Physician/Office setting the procedures and diagnosis information is provided by the provider to the health plan. The plan uses the minimum data needed to create a ‘mock’ claim, which simulates adjudication and provides an accurate liability without posting the claim. This request returns a detailed patient liability amount, at the claim and line item/procedure level.

Any of multiple methods may be used to perform the patient liability inquiry, including system to system, web services, Interfaces/adapters with PMS, HIS and other systems, and use of the Web Browser or portal. It should be noted that this enhanced method improves existing eligibility inquiry and benefit inquiry activities that occur in today's market, and lack level of detail to provide an accurate liability estimate. In certain embodiments of the present invention, a patient liability request is supported, which is a new pre-care transaction, and includes eligibility benefits, and detailed explanation of benefits for line level procedures.

The service provider receives detailed accurate patient liability for physician/group/outpatient settings; receives average estimated liability estimate for hospital/inpatient based on multiple methods such as average claims history, etc. A liability and/or eligibility inquiry submitted to the health plan may trigger configurable download from the health plan to the service provider (method, format, system interfaces, etc.) with PHR, credit check, financial account availability, financial, PHI and PHR consent/disclosure forms, benefits data, eligibility data, patient liability estimates—a) detailed claim and procedure level response (EOB style), or b) average cost based on type of service/visit.

At the scheduling and processing patients stage a service provider may interact with an administration system (e.g., via a website or other user interface) to perform scheduling and processing patients. For instance, the service provider may schedule an appointment with a patient. The service provider may confirm referrals, planned services. The service provider may ensure that the patient's health record is up to date (e.g., check with patient). The service provider may utilize existing EMR and newly received PHR data from the health plan as baseline. If gaps exist in the data, the service provider may request uploads from the patient and/or health plan to complete. The service provider may use the administration system to establish financial liability, and payment plan with patient. According to embodiments of the present invention, the service provider may provide the patient with expected patient liability amount owed using tools for real-time access to the health plan. The service provider may review the patient's financial information received from the health plan (e.g., via the administration system). The service provider may evaluate options for payment—health accounts, credit cards, payment plans, line of credit, county/government assistance programs, etc.

The service provider may discuss payment options with the patient, including healthcare accounts available (where appropriate), available lines of credit, offer new lines of credit, etc. The service provider may then collect payment and/or establish payment plan prior to check-in/visit, where appropriate/desired. The service provider may review pre-visit care plans, and/or utilize care plans provided by the health plan plus from the provider system. The service provider may schedule the appointment with the patient. In certain embodiments, the service provider may utilize PMS, HIS, and/or other provider systems to integrate with the health plan for patient scheduling, financial liability, and PHR/EMR transactions.

At the preparing patient's health records stage, a service provider may interact with an administration system (e.g., via a website or other user interface) to perform preparing patient's health records. For instance, the service provider may set up and maintain an electronic health record for the patient (e.g., within the administration system). This may be configured via integration with the EMR and PHR. The service provider may confirm privacy and consent parameters for exchange of PHI and PHR with health plan and constituents. The service provider may ensure the patient's record was updated from all sources/constituent based on scheduling, referrals, and pre-visits activities. The administration system may be used to provide/exchange/download-acquire PHR with health plan, providers, family, and other constituents supported by: a) multiple connectivity methods (browser, system interfaces, email with attachments, etc. Use various internet transfers methods, b) exchange PHR using multiple formats, including email, Adobe, HTML, HL7, X12, print file, etc., and/or c) multiple import/export methods, such as extract from desktop application or from external constituent, application, RHIO, etc.

In certain embodiments, interoperability and security connectivity management is used for PHR access and exchange, providing extracts, uploads, downloads, transfers, exchanges, etc. The formulary and patient health records may be provided to the service provider to assist with assessment and delivery of care.

An exemplary operational flow for actions supported for a healthcare consumer during and after healthcare service is rendered to the consumer according to one embodiment of the present invention is now briefly described for illustrative purposes. The exemplary flow identifies various stages at which a healthcare consumer may perform some action during and after receiving healthcare service, including patient (consumer) visits provider and checks-in, patient receives care, patient checks out, manage personal health records, manage health care treatment, and manage healthcare expenses, as examples.

At the consumer visits provider and checks-in stage, a consumer may visit a selected provider and check-in. For instance, the patient may visit a health facility and checks in at the front desk. The patient provides a clerk with his insurance identification card and other patient/membership information. The patient's pre-visit use of health plan tools should reduce providing or collecting duplicate data. The service provider confirms services planned, and shares accurate financial liability with the patient based on health plan tools. The patient confirms that financial and privacy authorizations have been setup with the health plan. The service provider accesses health plan patient records and accounts based on the patient's previous configuration of the health plan. The provider and patient may determine or refine the payment method. The patient may be asked to pay at this point, based on a method agreed upon, provider collection procedures, and office work-flow.

At the patient receives care stage, the patient receives care from the service provider. Additionally, PHR data may be exchanged between patient, health plan and identified constituents and may be available to providers during care. Formulary may be provided from the health plan to the provider to assist with drug selection and options. The Care management plan may be provided from the health plan to the provider. The provider shares care/treatment plan, prescriptions, and orders with patient; and the health plan system is updated for the patient (member). The services are rendered to the patient, and results of care/procedures including lab, X-ray, etc. are loaded into the patient's health plan PHR. The treatment plan is loaded into the patient's health plan care tool, for access after check-out.

At the patient checks out stage, the patient checks out. According to certain embodiments, the patient receives a bill at time of check-out. The patient may verify benefits, services allowed, prescriptions, etc. with information retrieved from the health plan member portal prior to receiving care. The patient receives the final liability amount at check-out, based on actual services performed, and reviews and reconciles issues with the provider based on treatment cost estimation from health plan prior to visit. The service provider and patient refine payment plan (based on previous agreement), or develop a payment method. The patient pays the remaining balance or according to payment plan. The patient may receive information from the provider re: discount programs and retail services available for their benefit plan. The patient may receive referral instructions to support treatment plan, including health plan's available networks, services, and discounts.

At the manage personal health records stage, the patient manages personal health records. According to certain embodiments, the patient receives a bill at time of check-out. The patient may confirm updates from the provider, pharmacy and other visits within the patient's PHR. The patient may manage privacy and consent parameters for exchange of PHI and PHR with the health plan and constituents. New service providers may be added based on care plan. In certain embodiments, the administration system enables provide/exchange/download-acquire PHR with health plan, providers, family, and other constituents. Further, the administration system enables the consumer to manage multiple formats, methods, security, and connectivity for PHR, as identified in consumer pre-care process. Also, the consumer can update the PHR with new service providers and constituents involved in care.

At the manage health care treatment stage, the patient manages his/her health care treatment. According to certain embodiments, the patient follows a treatment plan and enters a care management program. The patient may evaluate options presented by the administration system for purchases needed in the treatment program—e.g., therapy, drugs, equipment, etc. The patient may access health plan tools to get estimated costs of treatment plan needs; review cost of each service/item/activity, what is covered, and what discounts or programs are available to assist with purchasing decisions. The patient may evaluate costs and quality across different suppliers, providers, and treatment alternatives. Further, the patient may execute a treatment plan; make purchasing and service provider decisions based on information provider re: cost, quality, discounts, and alternatives. Further, the patient may, via the administration system, buy retail health products/services.

At the manage healthcare expenses stage, the patient manages health care expenses. According to certain embodiments, the patient receives, from the administration system, a financial health statement. The patient may go to the Pre-Care Process to manage financial accounts, investments, deductibles, and healthcare spending accounts. The patient may review claims and payment history; and/or utilize analytics to make decisions for future provider, service, and purchasing decisions. The patient may receive, via the administration system, patient detailed explanation of benefits for each inpatient visit, episode of care, outpatient services, etc. The patient can verify accurate posting of retail purchases related to treatment plan and ongoing healthcare management. The patient can receive bill(s) from providers rendering services; and/or reconcile payments using tools to evaluate care delivered, estimated liability, payment plans, and posting of payments. Further, the patient may receive liability and actual billing reconciliation report; and/or reconcile payment owed with provider based on reconciliation repot, tracking and history of patient liability calculations, provider bills, and payment posting including various payment method impacts.

An exemplary operational flow for actions supported for a healthcare service provider during and after rendering healthcare service to a consumer according to one embodiment of the present invention is now briefly described for illustrative purposes. The exemplary flow identifies various stages at which a healthcare service provider may perform some action during and after rendering healthcare service, including planning for patient appointment, provide patient care, billing and payment, and payment and reconciliation, as examples.

At the planning for patient appointment stage, the service provider plans for a patient appointment. For instance, the service provider contacts the patient for an appointment reminder. The service provider may conduct patient liability the night before and/or real time inquiry during check-in on all referred and scheduled and walk-in patients. The request may include data such as provider, member information, plan identification, date of service, planned procedures or services, diagnosis, etc. The service provider can recall previous liability requests from the health plan and re-submit for updated response and accurate patient liability estimate. Refer to the service provider's pre-care services for options/methods to calculate patient liability. In certain embodiments, multiple methods are used to perform the patient liability inquiry include system to system, web services, Interfaces/adapters with PMS, HIS and other systems, and use of the Web Browser or portal. The service provider may receive detailed accurate patient liability for physician/group/outpatient settings; receive average estimated liability estimate for hospital/inpatient based on multiple methods such as average claims history, etc. Further, as with pre-care liability estimates, the health plan will provide updates to the provider based on the configurable download from health plan to provider (method, format, system interfaces, etc.) with PHR, credit check, financial account availability, financial, PHI and PHR consent/disclosure forms, benefits data, eligibility data, patient liability estimates—a) detailed claim and procedure level response (EOB style), or b) average cost based on type of service/visit. The service provider can utilize this information to make decisions about financial transactions with the patient on the day of the visit, and in conjunction with previous payment agreements.

At the provide patient care stage, the service provider provides patient care. For instance, the service provider may access PHR data, formularies, treatment plan, and other information provided by health plan prior to patient care; and then the service provider delivers care. The service provider finalizes treatment plan based on delivery of care, and treatment guidelines received from the health plan. The services are rendered, and results of care/procedures including lab, X-ray, etc are used to create the bill for services, which later update the member's health plan PHR. The treatment plan is finalized and loaded into the member's health plan care tool. The service provider shares care/treatment plan, prescriptions, and orders with the member.

At the billing and payment stage, the service provider performs billing and receives payment for the service. For instance, the service provider generates a bill for services through their billing system, which generates a claim. The service provider has an option to submit and adjudicate a real time claim prior to member check-out. Patient liability requests from check-in can be retrieved, updated, and adjudicated for accurate liability and even posted, depending on the provider's billing system capabilities. The final bill is used to calculate the patient owed amount, and the actual final owed amount, if the option is select to post the claim. The result is the accurate patient financial liability, taking into account all financial accounts setup between the health plan and the patient. The service provider collects final payment from the member, or payment as defined in payment methods described in pre-care financial setup. The service provider utilizes PMS, HIS, browser, and other provider systems to submit the billing data as a final claim or liability estimate.

At the payment and reconciliation stage, the service provider receives payment and performs reconciliation for the service. For instance, the service provider receives payer explanation of benefits (FOB) at line item level for patient and provider paid amounts, for each claim that was submitted in real time, regardless of the submission method (Browser, PMS, HIS, etc.), Real time responses to billing issues enable provider to correct and resubmit directly to the health plan system in real time to ensure accurate and clean bill. The service provider receives payment and explanation of payment from payer. The provider posts payment, using electronic EOB and in real time with the billing system. Patient bills are created for the member balance. The provider and member reconcile differences between the payer's payment and the member's bill, and utilize health plan reconciliation reports and real time access to data to reduce cycles of billing. Interfaces with PMS, HIS, Clearinghouse vendors, Billing Services, and other third parties enable the automation of the system to system integration of the real time claim transactions, responses, and accurate payment collection at point of service.

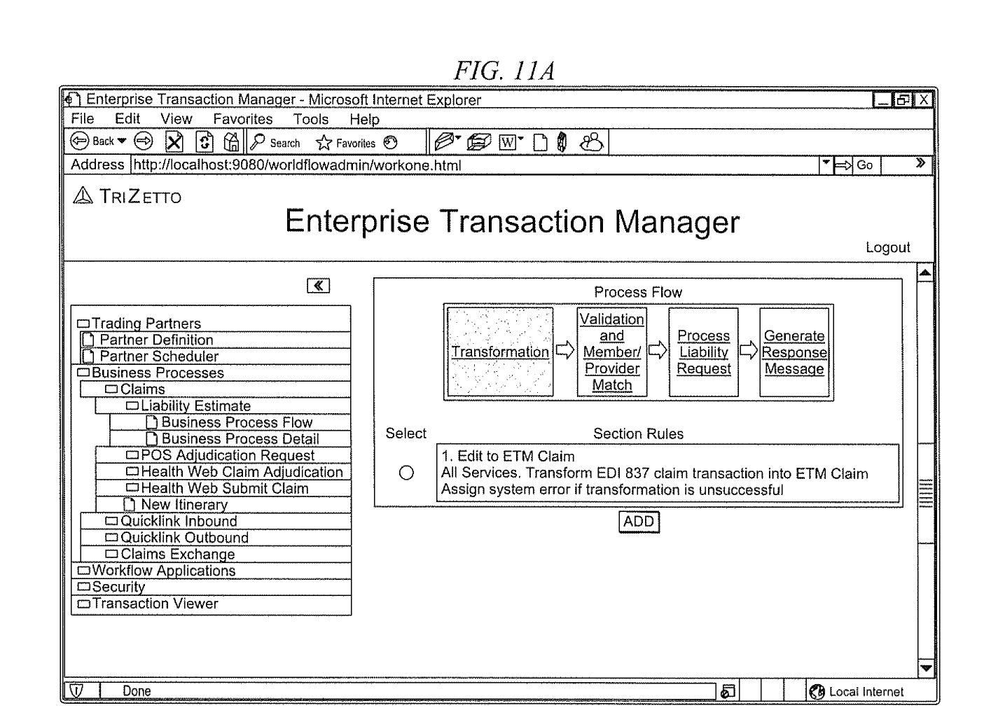

FIG. 8 shows an exemplary claim processing system 801 (e.g., the claim adjudication 301 shown in the exemplary embodiment of FIG. 3) that is implemented according to certain embodiments of the present invention. As shown, claim processing system 801 includes an interface 802 that is operable to receive electronic communication of data that comprises an actual claim for healthcare services, such as actual claim 803, and adjudicate such actual claim to determine a consumer's liability, the consumer's insurer's liability, etc., and return such healthcare payment information as an EOB. Exemplary claim adjudication systems that are operable for so processing electronically submitted claims are well-known in the art, and include as an example the software product commercially known as FACETS® available from The Trizetto Group™. Additionally, interface 802 of claim processing system 801 is operable to receive electronic communication of data that comprises a mock claim for healthcare services, such as mock claim 804, and process such mock claim to determine certain information pertaining to the mock claim, such as a consumer's liability, the consumer's insurer's liability, etc., and return such determined information, without committing/posting the determined liability to the insurer (as with an actual claim). In certain embodiments, mock claim 804 has information associated therewith, such as an indicator 805, from which claim adjudication system 801 is capable of recognizing the claim as a “mock” claim and thus not commit the determined liability amounts.

Accordingly, claim adjudication system 801 is operable to (e.g., via processing logic 406 of FIG. 4) process the received actual or mock claim through a given processing flow 806. Processing flow 806 may comprise any number of processing stages, such as stages 807, 808, etc., and may conclude with a commit/posting stage 809 at which the claim is committed for reimbursement by an insurer. Processing stages 807, 808, etc. may perform any number of operations pertaining to the received claim, such as determining the eligibility of the consumer identified on the claim, determining the eligibility of the service provider identified on the claim, determining an insurer's liability for services identified on the claim, determining the consumer's liability for the services identified on the claim, determining the consumer's healthcare funds (e.g., HSA account funds, etc.) available for payment of the consumer's liability, etc.

In this example, claim processing system 801 is operable to determine, in operational block 810, whether a received claim is a mock claim. Such determination may be made based on whether associated information, such as indicator 805, for a received claim indicates the claim is a mock claim. If determined that a received claim is a mock claim, the claim is processed just as an actual claim, except claim processing system 801 may interrupt the processing flow 806 in operational block 811 prior to committing the claim. The point at which such interruption occurs may be determined based on the associated information 805 in certain embodiments. For instance, the associated information 805 may thus be capable of selectively interrupting the processing flow 806 of claim processing system 801 at a desired stage of processing. In other embodiments, in response to determining the claim is a mock claim in block 810, the claim processing system 801 may, in operational block 812, rollback the claim after the processing flow 806 has concluded so as to uncommit the claim. Any information that is obtained as a result of the processing stages performed in processing flow 806 may be returned/output by the claim processing system 801 in operational block 813.

In still other embodiments, the mock claim 804 may be directed to (e.g., based on the associated indicator 805 identifying it as a “mock” claim) adjudication logic that does not include commit functionality. For instance, an actual claim 803 may be directed to adjudication logic having processing flow 806, which includes committing the claim in stage 809. In certain embodiments, adjudication logic may be implemented (instead of or in addition to adjudication logic 801 of FIG. 8) that has a different processing flow, which does not include the commit stage 809. Thus, a received mock claim 804 may be directed to such adjudication logic having a processing flow that determines liability but does not commit the claim. In other words, such adjudication logic may include various processing stages 807, 808, etc. for adjudicating the claim to accurately determine the liability of the parties (based on their pre-defined relationships/responsibilities), but does not include commit stage 809 so that the claim is not committed for payment of the determined liability. Accordingly, in certain embodiments, the associated information 805 triggers a claim adjudication system to modify its processing of the mock claim 804 by, for instance, interrupting its process flow at some point or rolling back its commit; whereas in other embodiments the associated information 805 may direct the mock claim 804 to adjudication logic having a processing flow that does not include committing the claim for payment of the determined liability. Any such embodiment is intended to be within the scope of the present invention for enabling adjudication of a received claim without presently committing it for payment of the determined liability.

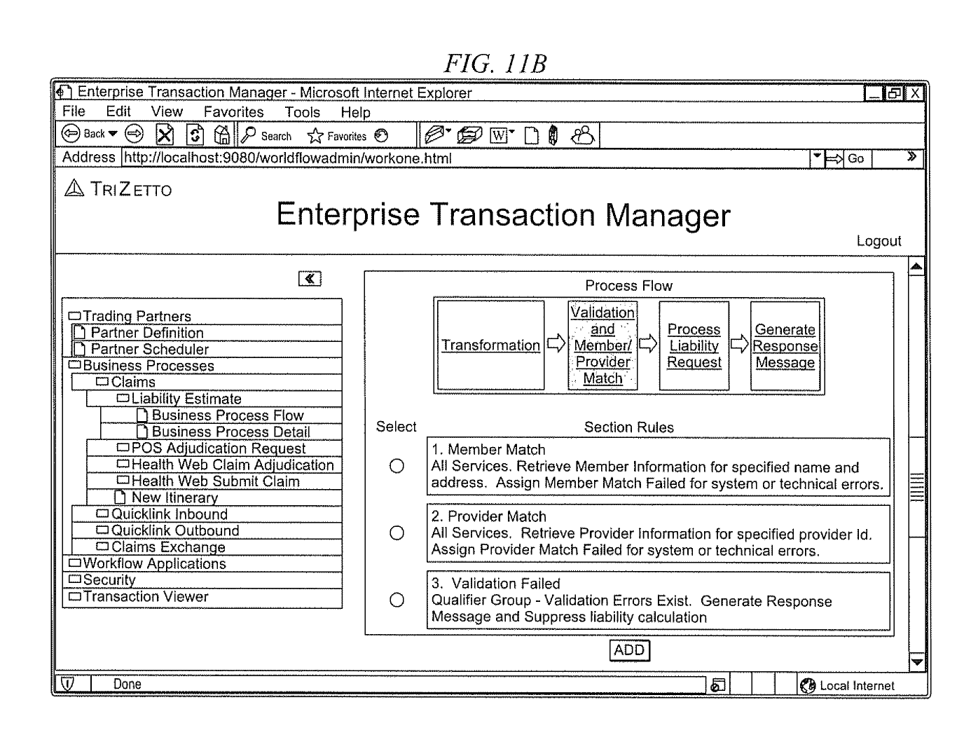

FIG. 9 shows an exemplary operational flow for processing of information for an office visit to a physician according to one embodiment of the present invention. In operational block 901, in response to a patient scheduling service with a physician, the physician logs into an administration system (e.g., via a website or other interface), and submits information identifying himself, the patient to be treated, and indicating that the physician desires a liability estimate for the patient. In block 902, the administration system validates the patient and the physician (e.g., verifies that the patient is a member of a healthcare plan and verifies that the physician is an eligible provider under such plan). In block 903, the physician submits a mock claim to the administration system in a format this is common for an actual claim. Such a mock claim may include a tag indicating that it is a mock claim, rather than an actual claim. In certain embodiments, the administration system receives information in HIPAA-compliant form, such as 270/271 and/or 837/835 requests. In block 904, the administration system processes the mock claim to replicate claim adjudication, and the administration system returns any errors for the mock claim (which the physician may then correct and re-submit a corrected mock claim) or the patient's estimated liability, just as the administration system would for an actual claim. As described further herein, such replication of the claim adjudication for the mock claim may be achieved through use of the same adjudication logic as is used for adjudicating actual claims in certain embodiments, or in other embodiments different adjudication logic (e.g., that does not include commit functionality) may be employed for such replication of the adjudication, as examples.

In block 905, the physician obtains the patient's personal health record. The physician may, in certain embodiments, update the patient's health record. In block 906, the physician provides an estimate of the patient's liability to the patient and/or collects pre-payment from the patient. The physician may evaluate various information, such as the patient's credit score, the balances of the patient's healthcare spending account(s), etc. to determine if and how much of a pre-payment is appropriate considering the estimated patient liability. In block 907, the physician treats the patient. In block 908, the physician creates a detailed claim (an actual claim) for the rendered service. In block 909, the actual claim is submitted to the payer (e.g., insurer) for payment. In certain embodiments, the claim is submitted via a PMS directly for real-time processing. In block 910, the submitted claim is adjudicated by the claim adjudication system (e.g., the administration system) and the actual patient liability is determined. In block 911, the payment of the insurer's liability may be submitted to the service provider.

In block 912, an explanation of benefits (EOB) and explanation of payment (HOP) are distributed and the physician reconciles with the patient to collect any additional payments or refund excess payments. In block 913, the patient pays any remaining portion, wherein such payment may be submitted via a debit card to access FSA, HRA, or HSA funds or via personal funds, as examples. For instance, a debit card payment may be made as described further in co-pending and commonly assigned U.S. patent application Ser. No. 11/213,996 titled “SYSTEM AND METHOD FOR DIRECTING PAYMENT OF A HEALTHCARE CONSUMER'S LIABILITY FROM A HEALTHCARE SPENDING ACCOUNT” filed Aug. 30, 2005, the disclosure of which is hereby incorporated herein by reference. As described further herein, in certain embodiments the above-mentioned processing of the actual claim and the reconciliation of the patient's actual liability may be performed at the point of service (e.g., prior to the patient leaving the physician's office).

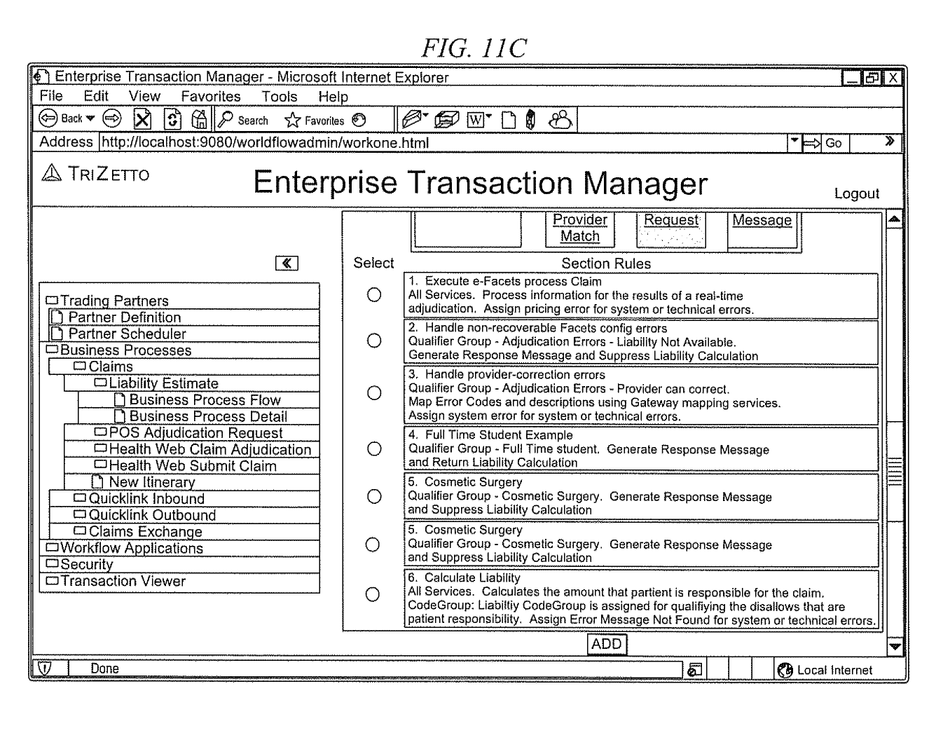

FIG. 10 shows an exemplary operational flow for processing of information for a hospital visit according to one embodiment of the present invention. In operational block 1001, a patient's treating physician requests patient admission to the hospital and sends information identifying the patient, the reason for admission, etc. to the hospital. In block 1002, the hospital receives the information from the physician and prepares to schedule an admission for the patient. In block 1003, the hospital staff enters (to an administration system, e.g., via a website or other interface) patient information to validate patient eligibility with the patient's health plan (insurer) and enters clinical data from the treating physician (e.g., diagnosis codes and procedure codes) to request an estimate of allowed expense and patient liability for the visit.

In block 1004, the administration system uses a back-end claim processing system to estimate the patient's liability. In this example, the back-end claim processing system (e.g., FACETS®) performs operations 10-1 through 10-7 to estimate the patient liability. For instance, in block 10-1, the service provider is identified, and in block 10-2 the correct provider contract is selected based on the member's network. The terms of the contract may be represented electronically so that the terms can be used by the claim processing system in accurately estimating the patient's liability. In block 10-3, the patient's plan of benefits and eligibility are identified. In block 10-4, the claim processing system determines if the member is eligible for the specific service(s) performed. In block 10-5, the claim processing system collects data on patient accumulators (e.g., deductibles, out-of-pocket maximum, co-payment maximum, co-insurance percentage, etc.) for use in calculating the patient's liability. In block 10-6, clinical data is received and allowed amounts, based on an evaluation of negotiated rates with the service provider, are returned to the hospital. In block 10-7, the claim processing system calculates the patient liability amount based on the patient's health plan (e.g., the allowed amounts, the plan benefits, etc.).

In block 1005, the claim processing system returns to the hospital (e.g., via the user interface with the administration system) patient eligibility information, estimated allowed amount, and estimated patient liability. In block 1006, the hospital communicates to the patient his/her estimated liability amount and requests payment thereof. In block 1007, the patient can pay his/her portion, wherein such payment may be submitted via a debit card to access an FSA, HRA, or HAS funds or via personal funds, as examples. In block 1008, the hospital obtains the patient's personal health record. In block 1009, the hospital may update the patient's health record.

In block 1010, care is delivered from the hospital to the patient. In block 1011, the hospital creates a detailed claim (an actual claim) for the rendered service. In block 1012, the created claim is submitted to the payer (e.g., insurer) for payment. In block 1013, the submitted claim is adjudicated by the claim processing/adjudication system (e.g., the administration system) and the actual patient liability is determined. In certain embodiments, the same claim processing system that was used for calculating the estimated patient liability is used for adjudicating the actual claim. In block 1014, an explanation of benefits (EOB) and explanation of payment (EOP) are distributed and the hospital reconciles with the patient to collect any additional payments or refund excess payments. In block 1015, the patient pays any remaining portion, wherein such payment may be submitted via a debit card to access FSA, HRA, or HAS funds or via personal funds, as examples.

In certain embodiments, the administration system enables a user (e.g., physician) to configure various aspects of the administration system. For instance, a service-oriented architecture (SOA), such as the exemplary architecture described further herein, may be employed to support such configurability. As one example, the administration system may enable each physician to set up common visit procedures that the physician can easily use for creating and submitting mock and/or actual claims with certain information pre-populated according to the physician-specific configuration. For instance, if a physician commonly performs certain types of treatment, examinations, etc., the physician can configure such common visit procedures to aid in easily creating and submitting mock or actual claims later without being required to populate an entire claim.

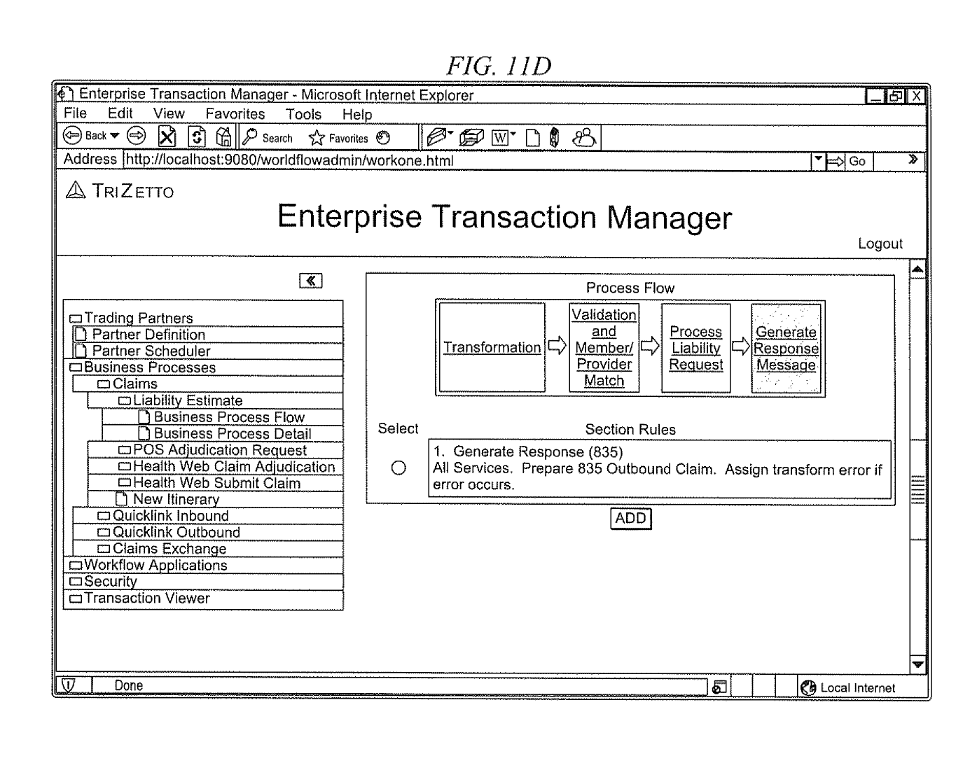

In certain embodiments, the administration system allows a user (e.g., physician) to create an “itinerary”, which may assemble various services/transactions into such itinerary. An exemplary interface provided by the administration system for enabling a user to create an itinerary is shown in FIGS. 11A-11D.

Once an itinerary is created, the user may submit a single transaction to the administration system to request that the services of an entire requested itinerary are all executed by the administration system. According to certain embodiments of the present invention, a user can specify rules at system runtime (as opposed to application development time) to configure the services. This improves configurability of the administration system to enable it to be better adapted for each user (e.g., configured as each physician desires), while minimizing user-specific development of the administration system application(s). A physician may create a unique itinerary for each partner and/or for each transaction, as examples. The configurability enables freedom of transaction or format types.

In certain embodiments, users of the administration system can set up rules, where the rules each include a) a qualifier that specifies whether the rule is to be applied to the transaction (e.g., claim) and b) an action to take if the rule qualifies. An exemplary claim processing system that employs such rules is described further in co-pending and commonly assigned U.S. patent application Ser. No. 09/577,386 titled “NOVEL METHOD AND APPARATUS FOR REPRICING A REIMBURSEMENT CLAIM AGAINST A CONTRACT” filed May 23, 2000, the disclosure of which is hereby incorporated herein by reference.

In certain embodiments, the liability calculation is configurable. For instance, a user (e.g., physician) may interact with the administration system to specify which variables to consider in the calculation of a patient's estimated liability. Thus, the user can configure the calculation to be as simple or as complex as desired. For instance, the user can configure the calculation employed for estimating a patient's liability to identically correspond to the calculation employed by a claim adjudication system in adjudicating an actual claim, or the user can configure the calculation of the estimated patient liability to be less complex than the calculation employed for an actual claim.

In certain embodiments, the user (e.g., physician, healthcare plan, etc.) can configure error processing. For instance, upon an error being detected in processing a mock or actual claim, the error may be handled in the manner configured specifically for such error. For example, certain error messages may be configured to be returned to the service provider (e.g., informing the service provider of an incorrect procedure code included in a mock claim), while other errors may be configured to be returned to the healthcare plan (or other party) indicating such error with a separate message being returned to the service provider (e.g., apologizing for the delay in processing).

In certain embodiments, a toolkit is provided to enable a user, such as a PMS, to incorporate the patient liability estimate into the user's system. For instance, the toolkit may enable a PMS to incorporate the patient liability estimate onto the PMS user interface (e.g., a button or other user interface may be added to the PMS user interface) enabling the PMS user interface to further interface with the administration system for requesting an estimate of patient liability (e.g., for submitting mock claims).

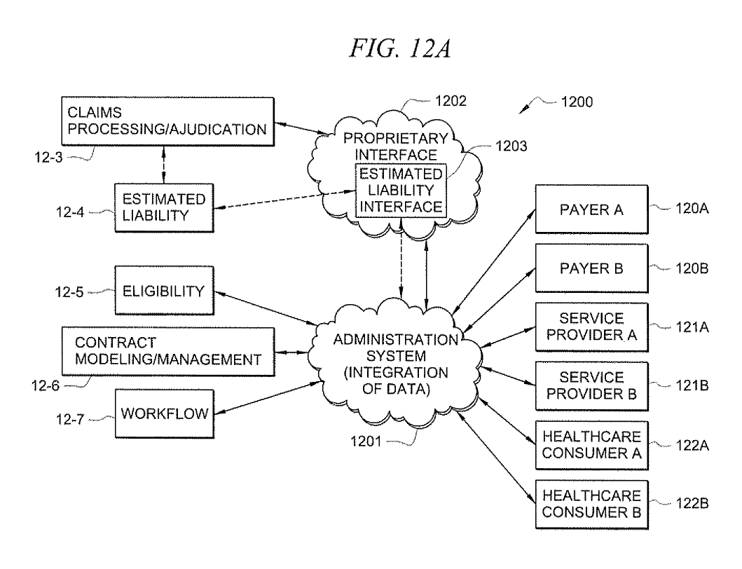

An exemplary system 1200 according to one embodiment of the present invention is shown in FIG. 12A. In system 1200, an administration system 1201 is provided to which various users, such as payers 120A-120B, service providers 121A-121B, and/or healthcare consumers 122A-122B can interface via a communication network, such as the Internet. The users may communicatively couple to administration system 1201 via a web browser, EDI, system-to-system, or other interface. Administration system 1201 enables the users to utilize various services, such as claims processing/adjudication 12-3 (e.g., as the claim processing system commercially known as FACETS®), estimated liability 12-4, eligibility determination 12-5, contract modeling/management 12-6, workflow 12-7, and claim re-pricing system 12-8 (e.g., the NetworX® re-pricer available from The TriZetto Group, Inc. In certain embodiments, the claim processing system 12-3 (e.g., FACETS®) provides real-time services for liability and adjudication. In certain embodiments, the claim re-pricing system 12-8 (e.g., NetworX®) enables automated pricing of 90-100% of facility claims, thus enabling great value to plans desiring, real-time POS.

In certain embodiments, administration system 1201 allows each of the users to configure the specific services that they desire to obtain. In the example shown in FIG. 12A, a proprietary interface 1202 for claims processing/adjudication system 12-3 is provided. Thus, actual claims can be submitted (through administration system 1201) for adjudication via proprietary interface 1202. In this example, a portion of the interface 1202 comprises an interface 1203 for obtaining estimated liability 12-4. For instance, a mock claim can be submitted using such interface 1203, whereby claims processing adjudication system 12-3 processes and adjudicates the mock claim to return an estimate of a healthcare consumer's liability.

FIG. 12B shows an exemplary system according to certain embodiments of the present invention. As show various parties may access administration system 1201 to gain the pre-service and/or post-service processing activities described further herein. That is, various parties may utilize the new transactions that are supported by the administration system 1201, such as the transaction for obtaining real-time claim processing (e.g., the transaction for obtaining a real-time patient liability estimation from the claim processing system). For instance, many service providers 121X may have existing relationships and interact with clearinghouses and/or third party billing systems 1221 for submitting claims for payment and/or processing other healthcare information pertaining to a specific service. According to certain embodiments of the present invention, such clearing houses and/or third party billing systems 1221 may have access to administration system 1201. Thus, the clearing houses and/or third party billing systems 1221 may request the real-time transactions described further herein from administration system 1201 in order to offer those features to service providers 121X. Thus, the service providers 121X need not change their existing relationships, in certain embodiments, in order to receive access to these new real-time transactions.

Similarly, many service providers 121Y may have existing relationships and interact with practice management systems (PMS) and/or health information systems (HIS) 1222 for submitting claims for payment and/or processing other healthcare information pertaining to a specific service. According to certain embodiments of the present invention, such PMS and/or HIS systems 1222 may have access to administration system 1201. Thus, the PMS and/or HIS systems 1222 may request the real-time transactions described further herein from administration system 1201 in order to offer those features to service providers 121Y. That is, the administration system 1201 integrates with PMS and/or HIS systems 1222 according, to certain embodiments. Thus, the service providers 121Y need not change their existing relationships, in certain embodiments, in order to receive access to these new real-time transactions.

Further, certain service providers 121Z may directly access administration system 1201 (e.g., via a health plan provider network 1223) for submitting claims for payment and/or processing other healthcare information pertaining to a specific service. According to certain embodiments of the present invention, service providers 121Z can thus request the real-time transactions described further herein from administration system 1201.

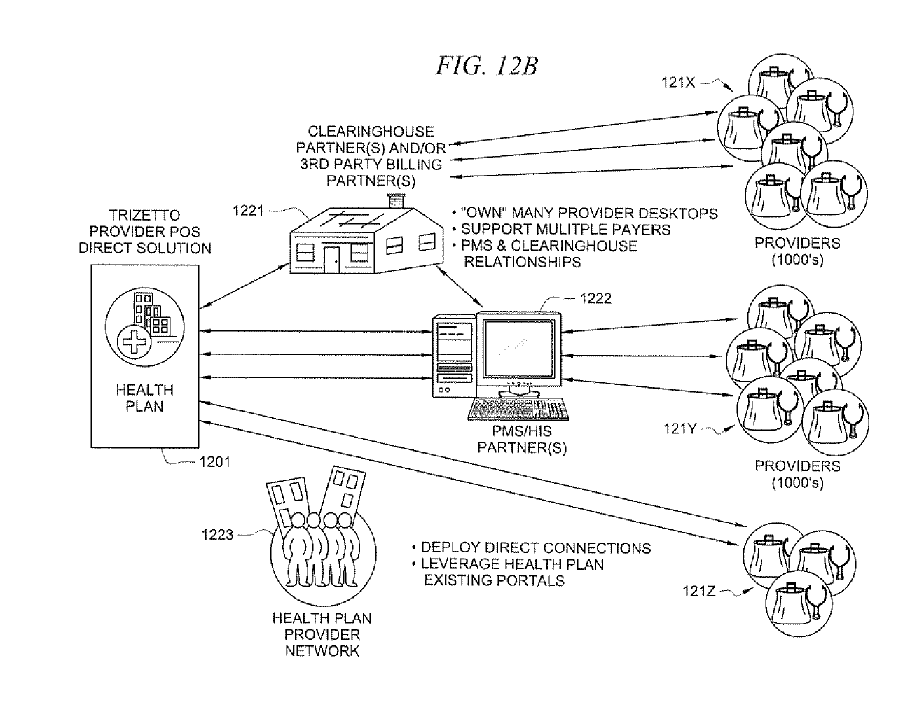

FIG. 13 shows an exemplary implementation of a service-oriented architecture 1300 that is employed for certain embodiments of the present invention, wherein an Enterprise Transaction Manager (ETM) 1301 implements the administration system 1201 (of FIG. 12A). As shown in FIG. 13, ETM 1301 is operable to execute various services 1307, such as claims processing services available via a claims engine with which ETM 1301 is communicatively coupled, such as FACETS® claims engine 1309 or other claims engine 1310, or services available via HIPS gateway 1308.

In this example, ETM 1301 enables user access via web user interfaces 1312. As described further herein, ETM 1301 may additionally or alternatively support access via various other access channels, such as IVR, EDI, etc. Web user interfaces 1312 may comprise an interface that is presented via a web browser application when the web browser application accesses an appropriate website. That is, a web server hosting such appropriate website may serve data to the client user's computer (e.g. the PC or other computer of a healthcare consumer, service provider or other authorized party), which a web browser application executing on the client's computer interprets to present the web user interfaces 1312. In this example, the web user interfaces 1312 comprise an interface for provider selection and authentication (1313), an interface for member entry (1314), an interface for claim data entry (1315), an interface for display of real-time patient liability (1316), and an interface for provider and claim profiles (1317). Various other interfaces may be included in certain embodiments.

In the example of FIG. 13, the interface for provider selection and authentication 1313 enables a user (e.g., service provider or healthcare consumer) to select a service provider of interest and request authentication. In response, the request is sent (e.g., via HIPAA-compliant service calls 1311) to ETM 1301, which performs provider authentication 1302. ETM 1301 generates a response 1306 that returns the provider authentication information back to the user (e.g., via web interface 1312).

The interface for member entry 1314 enables a user (e.g., service provider or healthcare consumer) to identify a member of interest (e.g., the healthcare consumer himself or the member to be serviced by a service provider). In response, a request for member authentication is sent (e.g., via HIPAA-compliant service calls 1311) to ETM 1301, which performs member authentication 1303, ETM 1301 generates a response 1306 that returns the member authentication information back to the user (e.g., via web interface 1312).

The interface for claim data entry 1315 enables a user (e.g., service provider or healthcare consumer) to enter claim data for a specific service of interest (e.g., specific service(s) for a given healthcare consumer to be the rendered by given service provider(s)). According to embodiments of the present invention, the user may submit the claim data as an actual claim to be processed and posted (e.g., via the back-end claims processing engine, such as FACETS® 1309 or other claims processing engine 1310), or the user may request an estimate of patient liability (e.g., submit the claim as a mock claim). If the user makes a full adjudication request, the claim is submitted to ETM 1301 via HIPAA-compliant service calls 1311, and in response ETM 1301 performs full adjudication 1305 on the claim. That is, ETM 1301 executes services 1307 to invoke a claims engine (e.g., FACETS® 1309 or other claims engine 1310) to fully adjudicate the claim. ETM 1301 then generates a response 1306 returning information for the fully adjudicated claim, such as the patient liability, EOB, etc.

In certain embodiments, interface 1312 includes an interface 1316 to enable the user to request a display of real-time patient liability (e.g., an estimate of the patient's liability for the claim). Such a request submits the claim data entered via interface 1315 to ETM 1301 via HIPAA-compliant service calls 1311. ETM 1301 invokes the appropriate services to perform the liability estimation 1304 for the submitted claim data. That is, ETM 1301 executes services 1307 to invoke a claims engine (e.g., FACETS® 1309 or other claims engine 1310) to process the claim data in order to determine patient liability (and an EOB, etc.) but not actually adjudicate and post the claim. In certain embodiments, the claim may be submitted by ETM 1301 to the claims engine with a flag that indicates the claim is a “mock” claim that is not to be adjudicated and posted, but is to be processed by the claims engine for obtaining the patient liability. In this mariner, the claim is processed by the claims engine as it would be if actually being adjudicated in order to accurately determine the patient's liability for the claim, but the claim is not fully adjudicated and posted for payment by the payer, etc. ETM 1301 then generates a response 1306 returning patient liability information (e.g., EOB, etc.) for the claim.

The interface for provider and claim profiles 1317 enables a user (e.g., service provider or healthcare consumer) to request provider and claim profiles.

According to certain embodiments, the architecture employed enables physicians and hospitals to connect to all of the health plans with which they do business, rather than just a single health plan. Thus, the solution is not a health plan-specific solution, but instead may be applied for real-time POS processing (e.g., for obtaining pre-service information and/or for conducting post-service processing in real-time) across a variety of different health plans.

According to certain embodiments, the SOA architecture employed provides the following: a) support for multi-channel transaction (e.g., enables access via website, EDI, system-to-system, and/or other access channels); b) externalized dynamic process automation (itinerary), including error handling; c) PMS/HIS/Clearinghouse integration; d) re-usable user-configurable business rules (which may be applied across multiple services); e) centralized data integration (e.g., data need not be entered separately for each service, but rather data entered for one service is integrated for use with other services); and f) the ability of the ETM to connect to multiple payers so the provider can utilize the real-time POS for all members (across multiple health plans). Some examples of configurable rules include, without limitation, the ability to perform provider specific transformations, provider specific edits, member identification and eligibility, custom liability calculations, step-by-step audit trail of the transaction, and flexible error handling and human workflow.

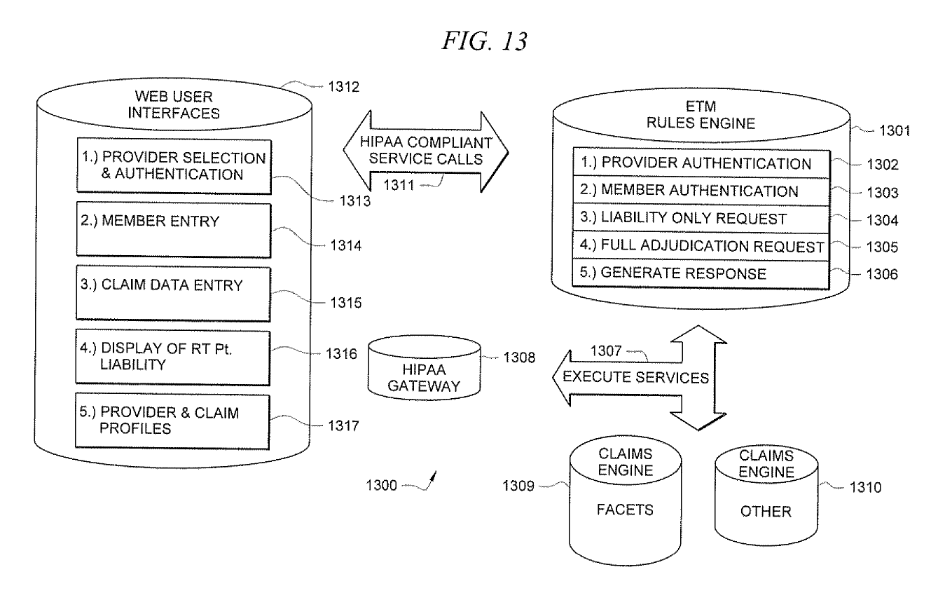

In view of the above, certain embodiments of the present invention enable access for real-time POS processing (e.g., for obtaining pre-service information, such as an estimation of patient liability, etc. and/or for post-service processing) by service providers and/or consumers via multiple input channels. Thus, access is supported if the service provider is using their own PMS, a website, IVR access, or other form of access channel. The same results can be obtained using any of the different channels, as the results (e.g., estimated patient liability, etc.) are based on the sane process (e.g., using a back-end claim processing system). FIG. 14 shows an exemplary block diagram of one embodiment, which supports access via multiple provider channels. As shown, ETM 1301 enables access to payer system(s) 1407 for obtaining the above-mentioned pre-service and/or post-service processing of information via various channels, such as a first PMS 1401, a second PMS 1402, a first hospital information system 1403, a second hospital information system 1404, a browser-based application 1405, and an IVR application 1406. It should be recognized that various other third parties may be supported as well, including as examples clearinghouses, billing services, PPOs, etc.

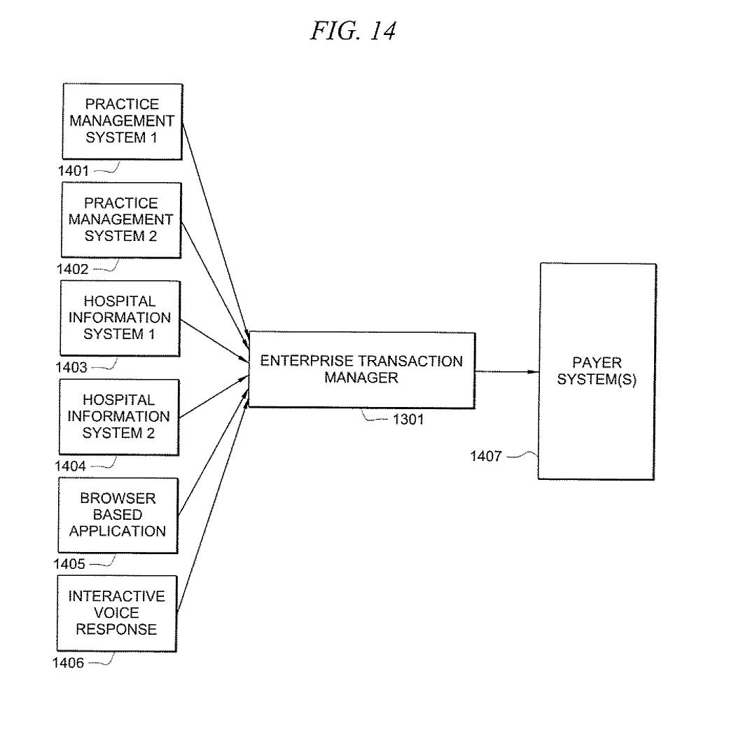

In certain embodiments, a unique set of business rules can be defined for each user (e.g., each service provider, each member, etc.). Further, a unique set of business rules can be defined for each channel for a given user. For instance, a first set of business rules may be defined for a service provider when accessing via the web, while a different set of business rules are defined for the service provider when accessing via the service provider's PMS. For instance, FIG. 15 shows an exemplary block diagram of one embodiment, which enables a payer 1407 to create an itinerary within ETM 1301 of business rules configured to process a claim for a specific provider over a specific input channel. For instance, in the example shown an itinerary of business rules 1507 is created for a first service provider when accessing the ETM via a PMS 1501. Another itinerary of business rules 1508 is created for the first service provider when accessing the ETM via a browser application 1502. Another itinerary of business rules 1509 is created for the first service provider when accessing the ETM via an IVR application 1503. Further in this example, an itinerary of business rules 1510 is created for a second service provider when accessing the ETM via a PMS 1504. Another itinerary of business rules 1511 is created for the second service provider when accessing the ETM via a browser application 1505. Another itinerary of business rules 1512 is created for the second service provider when accessing the ETM via an IVR application 1506.

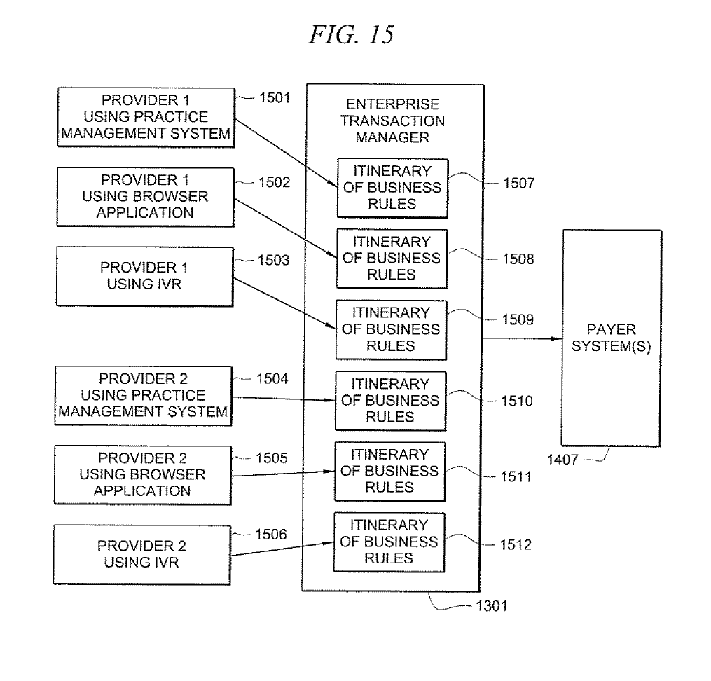

Further, in certain embodiments, the service provider can perform real-time processing for all of their payers, as the above-described solution can be implemented across multiple different health plans that are accepted by the service provider. Thus, the above solution is not limited to a specific health plan, but enables a service provider the flexibility of performing real-time processing across a plurality of different health plans. For instance, FIG. 16 shows an exemplary block diagram of one embodiment, which allows service provider(s) to connect to multiple payers via a single solution. More specifically, in this example, ETM 1301 enables the service provider system(s) 1601 to connect to multiple different payers 1602A-1602C for obtaining the above-mentioned pre-service and/or post-service real-time processing under the respective health plans of such payers.

When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

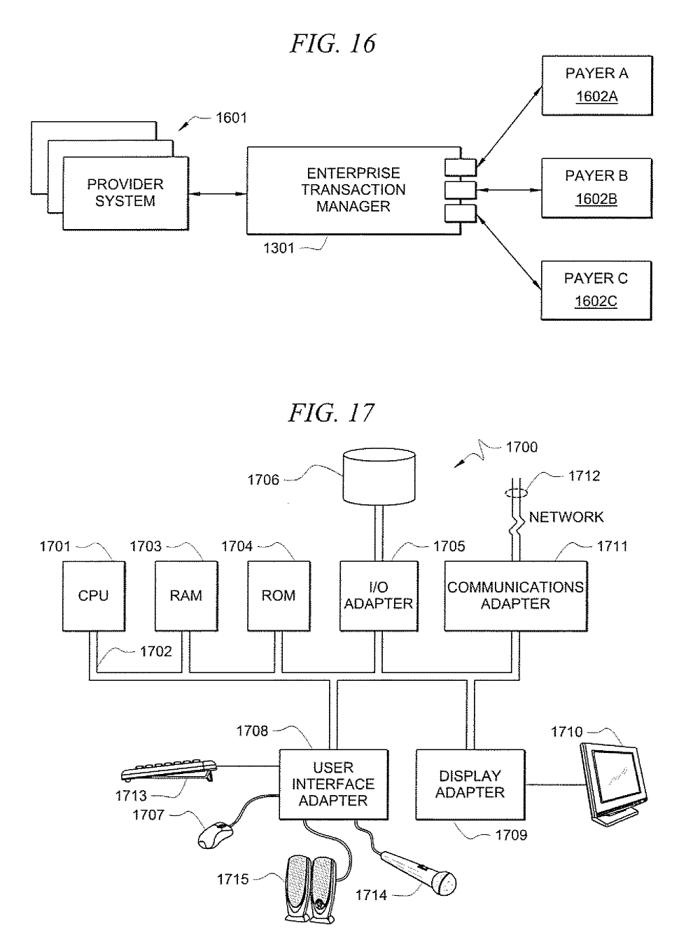

FIG. 17 illustrates an exemplary computer system 1700 on which various elements of embodiments of the present invention, such as software for presenting the exemplary user interfaces of FIGS. 6-7, software for presenting web interfaces described herein, the exemplary claim adjudication system described herein, etc., may be implemented according to certain embodiments of the present invention. Central processing unit (CPU) 1701 is coupled to system bus 1702. CPU 1701 may be any general-purpose CPU. The present invention is not restricted by the architecture of CPU 1701 (or other components of exemplary system 1700) as long as CPU 1701 (and other components of system 1700) supports the inventive operations as described herein. CPU 1701 may execute the various logical instructions according to embodiments of the present invention. For example, CPU 1701 may execute machine-level instructions according to the exemplary operational flows described above.

Computer system 1700 also preferably includes random access memory (RAM) 1703, which may be SRAM, DRAM, SDRAM, or the like. Computer system 1700 preferably includes read-only memory (ROM) 1704 which may be PROM, EPROM, EEPROM, or the like. RAM 1703 and ROM 1704 hold user and system data and programs, as is well known in the art.

Computer system 1700 also preferably includes input/output (I/O) adapter 1705, communications adapter 1711, user interface adapter 1708, and display adapter 1709. I/O adapter 1705, user interface adapter 1708, and/or communications adapter 1711 may, in certain embodiments, enable a user to interact with computer system 1700 in order to input information.

I/O adapter 1705 preferably connects to storage device(s) 1706, such as one or more of hard drive, compact disc (CD) drive, floppy disk drive, tape drive, etc. to computer system 1700. The storage devices may be utilized when RAM 1703 is insufficient for the memory requirements associated with storing data for operations of the elements described above (e.g., clam adjudication system, etc.). Communications adapter 1711 is preferably adapted to couple computer system 1700 to network 1712, which may enable information to be input to and/or output from system 1700 via such network 1712 (e.g., the Internet or other wide-area network, a local-area network, a public or private switched telephony network, a wireless network, any combination of the foregoing). User interface adapter 1708 couples user input devices, such as keyboard 1713, pointing device 1707, and microphone 1714 and/or output devices, such as speaker(s) 1715 to computer system 1700. Display adapter 1709 is driven by CPU 1701 to control the display on display device 1710 to, for example, display user interfaces as described above.

It shall be appreciated that the present invention is not limited to the architecture of system 1700. For example, any suitable processor-based device may be utilized for implementing the various elements described above (e.g., software for presenting the user interfaces, claim adjudication system, etc.), including without limitation personal computers, laptop computers, computer workstations, and multiprocessor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
receiving, at a claim processing system that is operable to adjudicate a claim for payment from an insurer for services rendered to a healthcare consumer, a request for estimated healthcare payment information for a service;
processing said request by said claim processing system for determining the requested estimated healthcare payment information, wherein the healthcare payment information is not committed for payment by said insurer; and
communicating, from the claim processing system, a response to the request that includes the estimated healthcare payment information.

2. The method of claim 1 wherein said service for which the estimated healthcare payment information is requested is a service that has not been rendered to the healthcare consumer.

3. The method of claim 1 wherein said receiving, processing, and communicating are performed in real-time.

4. The method of claim 1 wherein the healthcare payment information pertains to a specific healthcare service for a specific healthcare consumer, and wherein the receiving comprises:
receiving the request before the service is rendered to the healthcare consumer.

5. The method of claim 1 wherein the receiving comprises:
receiving the request from the healthcare consumer.

6. The method of claim 1 wherein the receiving comprises:
receiving the request from a healthcare service provider.

7. The method of claim 1 wherein the receiving a request comprises:
receiving a mock claim for the service, wherein the mock claim is in a common format as an actual claim for a service that has been rendered to the healthcare consumer with an indicator that indicates the mock claim is for service that has not been rendered to the healthcare consumer.

8. The method of claim 1 wherein the receiving a request comprises:
receiving a mock claim for the service, wherein the mock claim is in a common format as an actual claim for a service that has been rendered to the healthcare consumer with an indicator that indicates the mock claim is not to be presently committed for payment by the insurer.

9. The method of claim 1 wherein the healthcare payment information comprises an estimate of the healthcare consumer's liability for the service.

10. The method of claim 1 wherein the claim processing system computes the estimate.

11. The method of claim 1 wherein the communicating comprises:
communicating the healthcare consumer's liability for all items included in the service.

12. The method of claim 11 wherein the items included in the service comprise one or more of procedures, pharmaceuticals, and medical equipment.

13. The method of claim 1 wherein the communicating comprises:
communicating an explanation of benefits.

14. A method comprising:
receiving, at a claim processing system that is operable to adjudicate a claim for payment from an insurer for services rendered to a healthcare consumer, a mock claim for a service, wherein the mock claim has information associated therewith that indicates that it is not to be presently committed by the claim processing system for payment by the insurer;
processing said mock claim by claim adjudication logic of said claim processing system to determine an estimate of healthcare payment information for the service; and
outputting, from the claim processing system, the estimated healthcare payment information for the service.

15. The method of claim 14 wherein the mock claim is for a service that has not been rendered to the healthcare consumer

16. The method of claim 14 wherein said receiving, processing, and outputting are performed in real-time.

17. The method of claim 14 wherein the estimated healthcare payment information pertains to a specific healthcare service for a specific healthcare consumer, and wherein the receiving comprises:
receiving the request before the service is rendered to the healthcare consumer.

18. The method of claim 14 wherein the receiving comprises:
receiving the request from the healthcare consumer.

19. The method of claim 14 wherein the receiving comprises:
receiving the request from a healthcare service provider.

20. The method of claim 14 wherein the mock claim is in a common format as an actual claim for a service that has been rendered to the healthcare consumer with information associated therewith that indicates the mock claim is for service that has not been rendered to the healthcare consumer.

21. The method of claim 14 wherein the mock claim is in a common format as an actual claim for a service that has been rendered to the healthcare consumer with an indicator that indicates the mock claim is not to be committed by the claim processing system.

22. The method of claim 14 wherein the estimated healthcare payment information comprises an estimate of the healthcare consumer's liability for the service identified in the mock claim.

23. The method of claim 22 wherein the claim processing system computes the estimate.

24. The method of claim 14 wherein the estimated healthcare payment information comprises the healthcare consumer's liability for all items included in the service defined in the mock claim.

25. The method of claim 24 wherein the items included in the service defined in the mock claim comprise one or more of procedures, pharmaceuticals, and medical equipment.

26. The method of claim 14 wherein the outputting further comprises;
outputting an explanation of benefits for the mock claim.

27. The method of claim 14 further comprising:
the claim processing system not committing the estimated healthcare payment information determined for the mock claim.

28. The method of claim 27 further comprising:
receiving, at the claim processing system, a request to convert the mock claim to an actual claim.

29. The method of claim 28 further comprising:
responsive to the request to convert, the claim processing system processing the mock claim as an actual claim for service rendered to the healthcare consumer to determine actual healthcare payment information.

30. The method of claim 29 further comprising:
the claim processing system committing the determined actual healthcare payment information.

31. The method of claim 14 wherein said processing said mock claim by said claim adjudication logic further comprises:
determining any error code that would be generated by the claim processing system if the mock claim were an actual claim; and
outputting, by said claim processing system, an identification of the determined error code.

32. A method comprising:
receiving, at a claim processing system is operable to adjudicate a claim for payment from an insurer for services rendered to a healthcare consumer, a mock claim for a service, wherein the mock claim has information associated therewith that indicates that processing of said mock claim by said claim processing system is to be interrupted prior to committing the mock claim for payment by the insurer;
processing said mock claim by claim adjudication logic of said claim processing system to determine information pertaining to said mock claim;
interrupting processing of said mock claim by said claim processing system prior to committing the mock claim for payment by the insurer; and
outputting, from the claim processing system, the determined information.

33. The method of claim 32 wherein said determined information pertaining to said mock claim comprises an estimate of healthcare payment information for the service identified in said mock claim.

34. The method of claim 32 further comprising:
determining, from information associated with said mock claim, a stage in a processing flow of said adjudication logic at which to perform said interrupting of said processing.

35. The method of claim 32 wherein the outputting comprises:
communicating consumer liability for all items included in the service identified in the mock claim.

36. The method of claim 35 wherein the items included in the service comprise one or more of procedures, pharmaceuticals, and medical equipment.

37. The method of claim 32 wherein the outputting further comprises:
communicating an explanation of benefits.

38. A system comprising:
adjudication logic that is operable to adjudicate a claim for payment from an insurer for services rendered to a healthcare consumer; and
an interface to said adjudication logic that enables receipt by said adjudication logic of a mock claim for a service that is not to be presently committed for payment by the insurer;
wherein said adjudication logic is operable to process the mock claim to determine an estimate of healthcare payment information for the service.

39. The system of claim 38 wherein the adjudication logic does not commit the mock claim.

40. The system of claim 38 wherein the mock claim is for a service that has not been rendered to the healthcare consumer

41. The system of claim 40 wherein the adjudication logic processes the mock claim as a claim for a service that has been rendered to the healthcare consumer, except the adjudication logic does not commit the mock claim.

42. The system of claim 38 wherein the adjudication logic is operable to output the estimated healthcare payment information for the service.

43. The system of claim 38 wherein the adjudication logic is operable to process the mock claim in real-time.

44. The system of claim 38 further comprising:
an interface to said adjudication logic that enables receipt by said adjudication logic of a request to commit the mock claim for payment by the insurer.

45. A system comprising:
adjudication logic that is operable to adjudicate a claim for payment from an insurer to a service provider for services rendered to a healthcare consumer;
an interface to said adjudication logic that enables receipt by said adjudication logic of a mock claim for a service, wherein the mock claim has information associated therewith that indicates that processing of said mock claim by said adjudication logic is to be interrupted prior to committing the mock claim for payment by the insurer;
wherein the adjudication logic is operable to process a received mock claim to determine information pertaining to said mock claim;
wherein the adjudication logic is operable to interrupt its processing of said mock claim prior to committing the mock claim for payment by the insurer; and
wherein the adjudication logic is operable to output the determined information pertaining to said mock claim.

46. The system of claim 45 wherein the mock claim is for a service that has not been rendered to the healthcare consumer.

47. The system of claim 45 wherein said adjudication logic is operable to process the mock claim to determine an estimate of healthcare payment information for the service.
